(19) United States
(12) Patent Application Publication
(10) Pub. No.: US 2023/0321846 A1
(43) Pub. Date: Oct. 12, 2023

(54) ROBOTIC SYSTEMS WITH OBJECT HANDLING MECHANISM AND ASSOCIATED SYSTEMS AND METHODS

(71) Applicant: MUJIN, Inc., Tokyo (JP)

(72) Inventors: Lei Lei, Guangzhou (CN); Xutao Ye, Guangzhou (CN); Xu Chen, Guangzhou (CN); Yixuan Zhang, Guangzhou (CN); Zhili Lai, Guangzhou (CN); Long Du, Guangzhou (CN); Pai Zheng, Guangzhou (CN); Rosen Nikolaev Diankov, Tokyo (JP)

(21) Appl. No.: 18/296,762

(22) Filed: Apr. 6, 2023

Related U.S. Application Data
(60) Provisional application No. 63/327,811, filed on Apr. 6, 2022.

(51) Int. Cl. B25J 15/06; B25J 9/16; B25J 19/02

(52) U.S. Cl. CPC B25J 15/0616; B25J 9/1612; B25J 19/023

(57) ABSTRACT

Robotic systems with griping mechanisms, and related systems and methods are disclosed herein. In some embodiments, the robotic system includes a robotic arm and an end-of-arm tool coupled to the robotic arm. The end-of-arm tool can include a frame and an actuator system coupled to the frame. The end-of-arm tool can also include a first clamping component, a second clamping component, and a third clamping component each coupled to the frame. The third clamping component is positioned peripheral to the second clamping component with respect to the first clamping component and includes one or more extension portions extending toward the first clamping component. The actuator system can be coupled to the first, second, and/or third clamping components to move the first, second, and/or third clamping components along a transverse axis of the end-of-arm tool.

### CROSS-REFERENCE TO RELATED APPLICATION(S)

The present application claims the benefit of U.S. Provisional Patent Application No. 63/327,811, filed Apr. 6, 2022, the entirety of which is incorporated herein by reference.

### TECHNICAL FIELD

The present technology is generally related to robotic systems with gripping mechanisms, and more specifically robotic systems with features for planning a packing operation and adjusting a gripper mechanism based on the packing operation.

### BACKGROUND

With their ever-increasing performance and lowering cost, many robots (e.g., machines configured to automatically/autonomously execute physical actions) are now extensively used in many fields. Robots, for example, can be used to execute various tasks (e.g., manipulate or transfer an object through space) in manufacturing and/or assembly, packing and/or packaging, transport and/or shipping, etc. In executing the tasks, the robots can replicate human actions, thereby replacing or reducing human involvements that are otherwise required to perform dangerous or repetitive tasks.

However, despite the technological advancements, robots often lack the sophistication necessary to duplicate human interactions required for executing larger and/or more complex tasks. Accordingly, there remains a need for improved techniques and systems for managing operations of and/or interactions between robots.

### BRIEF DESCRIPTION OF THE DRAWINGS

FIG. 1 is an illustration of an example environment in which a robotic system with a gripping mechanism can operate in accordance with some embodiments of the present technology.

FIG. 2 is a block diagram illustrating the robotic system of FIG. 1 in accordance with some embodiments of the present technology.

FIG. 3 is an illustration of a robotic unit configured in accordance with some embodiments of the present technology.

FIG. 4 is a partially schematic illustration of an end-of-arm tool configured in accordance with some embodiments of the present technology.

FIGS. 5A-5D are partially schematic illustrations of an end-of-arm tool gripping a target object in accordance with some embodiments of the present technology.

FIGS. 6A-6D are partially schematic illustrations of an end-of-arm tool gripping a plurality of target objects in accordance with some embodiments of the present technology.

FIG. 7A is a partially schematic top view of a plan for a packing operation in accordance with some embodiments of the present technology.

FIGS. 7B-7E are partially schematic illustrations of an end-of-arm tool packing a shipping unit in accordance with the plan of FIG. 7A in accordance with some embodiments of the present technology.

FIG. 8A is a flow diagram of a process for a packing operation in accordance with some embodiments of the present technology.

FIG. 8B is a flow diagram of a process for picking one or more target objects during the packing operation of FIG. 8A in accordance with some embodiments of the present technology.

FIG. 8C is a flow diagram of a process for placing one or more target objects during the packing operation of FIG. 8A in accordance with some embodiments of the present technology.

FIGS. 9 and 10 are partially schematic top views of plans for packing operations in accordance with further embodiments of the present technology.

FIGS. 11A and 11B are partially schematic illustrations of an end-of-arm tool during a packing operation in accordance with further embodiments of the present technology.

FIG. 12 is a partially schematic illustration of an end-of-arm tool configured in accordance with further embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

For ease of reference, the end effector and the components thereof are sometimes described herein with reference to top and bottom, upper and lower, upwards and downwards, a longitudinal plane, a horizontal plane, an x-y plane, a vertical plane, and/or a z-plane relative to the spatial orientation of the embodiments shown in the figures. It is to be understood, however, that the end effector and the components thereof can be moved to, and used in, different spatial orientations without changing the structure and/or function of the disclosed embodiments of the present technology.

### DETAILED DESCRIPTION

### Overview

Robotic systems with hybrid gripping mechanisms and related systems and methods are disclosed herein. In some embodiments, the robotic system includes a robotic arm and an end-of-arm tool coupled to the robotic arm. The end-of-arm tool can include a frame that has a first axis (e.g., a longitudinal axis) and a second axis (e.g., a transverse axis) at least partially orthogonal to the first axis. The end-of-arm tool can also include an actuator system and first, second, and third clamping components each coupled to the frame.

The first clamping component (sometimes also referred to herein as an external clamping component) extends along the first axis and along an outer edge of the frame. As a result, the first clamping component can define an outer wall of the end-of-arm tool. The second clamping component (sometimes also referred to herein as an internal clamping component) extends along the first axis and is operably coupled to the actuator system to move along the second axis toward and away from the first clamping component. During operation, the first and second clamping components can engage opposing side surfaces of one or more target objects to clamp the one or more target objects therebetween.

The third clamping component (sometimes also referred to herein as a support clamping component) extends along the first axis peripheral to the second clamping component with respect to the first clamping component (e.g., is positioned further from the first clamping component than the second clamping component) and includes one or more extension portions extending toward the first clamping component. The one or more extension portions are at an elevation below a lower edge of the second clamping component. The third clamping component is also operably coupled to the actuator system to move along the second axis toward and away from the first clamping component. During operation, the third clamping component can move toward the first clamping component, after the first and second clamping components have engaged the side surfaces of the one or more target objects, to position the one or more extension portions beneath a lower surface of the one or more target objects. As a result, the one or more extension portions can help support the one or more target objects while the robotic system transports the one or more target objects. Additionally, or alternatively, the third clamping component can help stabilize the end-of-arm tool after the first and second clamping components have engaged the side surfaces of the one or more target objects (e.g., to add rigidity, reinforce the engagement, and the like).

In some embodiments, the actuator system includes a track carried by the frame and extending along the second axis, a first carriage operably coupled between the track and the second clamping component, a second carriage operably coupled between the track and the third clamping component, and a driver operably coupled to the first and second carriages. The movement of the first carriage can control the movement of the second clamping component along the second axis. Similarly, the movement of the second carriage can control the movement of the third clamping component along the second axis.

In some embodiments, the second clamping component and/or the third clamping component include a bracing bracket facilitating the coupling to the actuator system. The bracing bracket can extend along a third axis at least partially orthogonal to the first and second axes and help transmit motion from the actuator system throughout the second clamping component and/or the third clamping component. For example, the bracing bracket can help ensure that motion from the actuator system is not only applied to an upper edge of the second clamping component and/or the third clamping component (which would, for example, result in a pivoting force when the second clamping component engages the side surface of the one or more target objects). When the second clamping component includes a bracing bracket, the third clamping component can include an opening aligned with the bracing bracket along the second axis. The opening can be configured to nest with the bracing bracket when the third clamping component is adjacent to the second clamping component, thereby allowing the third clamping component to move closer to (and/or abut) the second clamping component.

In some embodiments, the second clamping component includes a gripping substrate disposed on the surface of the second clamping component facing the first clamping component. The gripping substrate can help reduce the amount that the one or more target objects can slip once engaged by the first and second clamping components.

In some embodiments, the first clamping component has a thickness of less than 3 centimeters. As discussed in more detail below, the relatively thin profile of the first clamping component can allow the first end-of-arm tool to place the one or more target objects in close proximity to other objects (e.g., previously moved objects) and/or barriers (e.g., a wall of a shipping container). For example, during operation, the end-of-arm tool can be oriented such that the first clamping component is between the one or more target objects and previously placed objects at a destination. In this example, the thickness of the first clamping component is the limiting factor on how close the one or more target objects can be placed. Accordingly, when the first clamping component has a relatively thin profile, the one or more target objects can be placed in close proximity to the other objects (e.g., tightly packed at the destination).

In some embodiments, the end-of-arm tool includes a sensor system coupled to the frame and positioned to measure an environment around the end-of-arm tool. For example, the sensors can include an imaging system positioned to measure one or more parameters of the one or more target objects, objects surrounding the one or more target objects, objects at a destination for the target objects, an environment around the end-of-arm tool while transporting the one or more target objects, and the like.

In some embodiments, the end-of-arm tool includes one or more retractable arms carried by the frame. Each of the one or more retractable arms can include a suction gripping component and can be movable between a first position and a second position. In the first position, the suction gripping component can be at a first elevation above the lower edge of the second clamping component (e.g., out of the way of the first and second clamping components as they engage the one or more target objects) In the second position, the suction gripping component can be at a second elevation below the lower edge of the second clamping component (e.g., able to grab an object, such as a slip sheet or other divider).

Several details describing structures or processes that are well-known and often associated with robotic systems and subsystems, but that can unnecessarily obscure some significant aspects of the disclosed techniques, are not set forth in the following description for purposes of clarity. Moreover, although the following disclosure sets forth several embodiments of different aspects of the present technology, several other embodiments can have different configurations or different components than those described in this section. Accordingly, the disclosed techniques can have other embodiments with additional elements or without several of the elements described below.

Many embodiments or aspects of the present disclosure described below can take the form of computer-executable or controller-executable instructions, including routines executed by a programmable computer or controller. Those skilled in the relevant art will appreciate that the disclosed techniques can be practiced on computer or controller systems other than those shown and described below. The techniques described herein can be embodied in a special-purpose computer or data processor that is specifically programmed, configured, or constructed to execute one or more of the computer-executable instructions described below. Accordingly, the terms “computer” and “controller” as generally used herein refer to any data processor and can include Internet appliances and handheld devices, including palm-top computers, wearable computers, cellular or mobile phones, multi-processor systems, processor-based or programmable consumer electronics, network computers, mini computers, and/or the like. Information handled by these computers and controllers can be presented at any suitable display medium, including a liquid crystal display (LCD). Instructions for executing computer- or controller-executable tasks can be stored in or on any suitable computer-readable medium, including hardware, firmware, or a combination of hardware and firmware. Instructions can be contained in any suitable memory device, including, for example, a flash drive, USB device, and/or other suitable medium.

The terms “coupled” and “connected,” along with their derivatives, can be used herein to describe structural relationships between components. It should be understood that these terms are not intended as synonyms for each other. Rather, in particular embodiments, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements co-operate or interact with each other (e.g., as in a cause-and-effect relationship, such as for signal transmission/reception or for function calls), or both.

### Example Environment for Robotic System

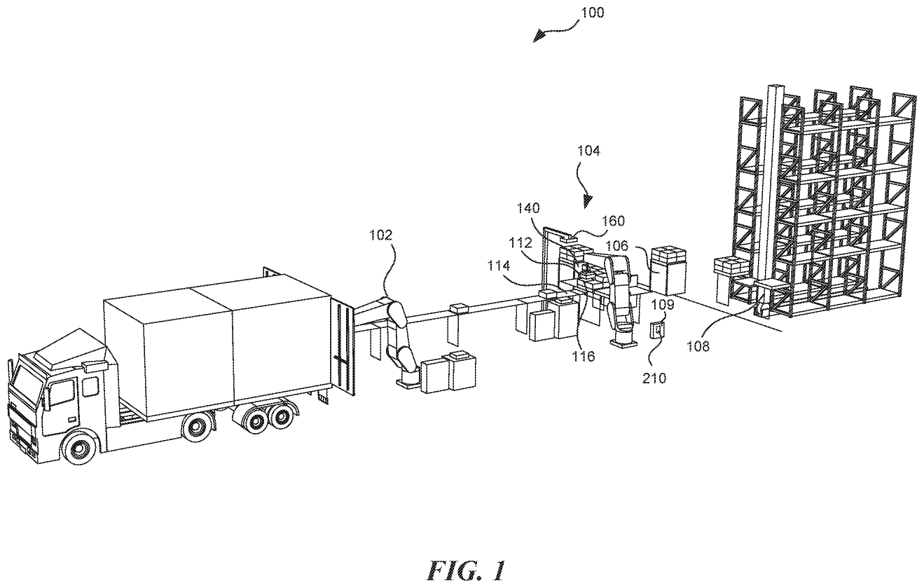

FIG. 1 is an illustration of an example environment in which a robotic system 100 with an object handling mechanism can operate. The operating environment for the robotic system 100 can include one or more structures, such as robots or robotic devices, configured to execute one or more tasks. Aspects of the object handling mechanism can be practiced or implemented by the various structures and/or components.

In the example illustrated in FIG. 1, the robotic system 100 can include an unloading unit 102, a transfer unit 104, a transport unit 106, a loading unit 108, or a combination thereof in a warehouse, a distribution center, or a shipping hub. Each of the units in the robotic system 100 can be configured to execute one or more tasks. The tasks can be combined in sequence to perform an operation that achieves a goal, for example, such as to unload objects from a vehicle, such as a truck, trailer, a van, or train car, for storage in a warehouse or to unload objects from storage locations and load them onto a vehicle for shipping. In another example, the task can include moving objects from one location, such as a container, bin, cage, basket, shelf, platform, pallet, or conveyor belt, to another location. Each of the units can be configured to execute a sequence of actions, such as operating one or more components therein, to execute a task.

In some embodiments, the task can include interaction with a target object 112, such as manipulation, moving, reorienting or a combination thereof, of the object. The target object 112 is the object that will be handled by the robotic system 100. More specifically, the target object 112 can be the specific object among many objects that is the target of an operation or task by the robotics system 100. For example, the target object 112 can be the object that the robotic system 100 has selected for or is currently being handled, manipulated, moved, reoriented, or a combination thereof. The target object 112, as examples, can include boxes, cases, tubes, packages, bundles, an assortment of individual items, or any other object that can be handled by the robotic system 100.

As an example, the task can include transferring the target object 112 from an object source 114 to a task location 116. The object source 114 (e.g., a starting location) can be a receptacle for storage of objects. The object source 114 can include numerous configurations and forms. For example, the object source 114 can be a platform, with or without walls, on which objects can be placed or stacked, such as a pallet, a shelf, or a conveyor belt. As another, the object source 114 can be a partially or fully enclosed receptacle with walls or lid in which objects can be placed, such as a bin, cage, or basket. In some embodiments, the walls of the object source 114 with the partially or fully enclosed can be transparent or can include openings or gaps of various sizes such that portions of the objects contained therein can be visible or partially visible through the walls. In yet another example, the object source 14 can be a conveyor belt and/or any other suitable assembly line location.

FIG. 1 illustrates examples of the possible functions and operations that can be performed by the various units of the robotic system 100 in handling the target object 112 and it is understood that the environment and conditions can differ from those described hereinafter. For example, the unloading unit 102 can be a vehicle offloading robot configured to transfer the target object 112 from a location in a carrier, such as a truck, to a location on a conveyor belt. Also, the transfer unit 104, such as a palletizing robot, can be configured to transfer the target object 112 from a location on the conveyor belt to a location on the transport unit 106, such as for loading the target object 112 on a pallet on the transport unit 106. In another example, the transfer unit 104 can be a piece-picking robot configured to transfer the target object 112 from one container to another container. In completing the operation, the transport unit 106 can transfer the target object 112 from an area associated with the transfer unit 104 to an area associated with the loading unit 108, and the loading unit 108 can transfer the target object 112, such as by moving the pallet carrying the target object 112, from the transfer unit 104 to a storage location, such as a location on the shelves. Details regarding the task and the associated actions are described below.

For illustrative purposes, the robotic system 100 is described in the context of a shipping center; however, it is understood that the robotic system 100 can be configured to execute tasks in other environments or for other purposes, such as for manufacturing, assembly, packaging, healthcare, or other types of automation. It is also understood that the robotic system 100 can include other units, such as manipulators, service robots, modular robots, that are not shown in FIG. 1. For example, in some embodiments, the robotic system 100 can include a depalletizing unit for transferring the objects from cages, carts, or pallets onto conveyors or other pallets, a container-switching unit for transferring the objects from one container to another, a packaging unit for wrapping the objects, a sorting unit for grouping objects according to one or more characteristics thereof, a piece-picking unit for manipulating the objects differently, such as sorting, grouping, and/or transferring, according to one or more characteristics thereof, or a combination thereof.

The robotic system 100 can include a controller 109 configured to interface with and/or control one or more of the robotic units. For example, the controller 109 can include circuits (e.g., one or more processors, memory, etc.) configured to derive motion plans and/or corresponding commands, settings, and/or the like used to operate the corresponding robotic unit. The controller 109 can communicate the motion plans, the commands, settings, etc. to the robotic unit, and the robotic unit can execute the communicated plan to accomplish a corresponding task, such as to transfer the target object 112 from the object source 114 to the task location 116.

### Suitable System

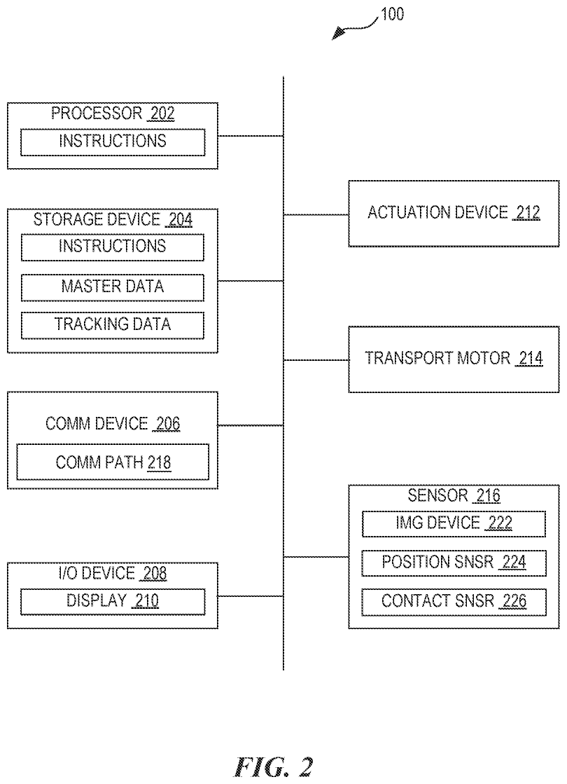

FIG. 2 is a block diagram illustrating the robotic system 100 in accordance with one or more embodiments of the present technology. In some embodiments, for example, the robotic system 100 can include electronic devices, electrical devices, or a combination thereof, such as a control unit 202 (sometimes also referred to herein as a “processor 202”), a storage unit 204, a communication unit 206, a system input/output (I/O) device 208 having a system interface 210 (sometimes also referred to herein as a “user interface 210”), one or more actuation devices 212, one or more transport motors 214, one or more sensor units 216, or a combination thereof that are coupled to one another, integrated with or coupled to one or more of the units or robots described in FIG. 1 above, or a combination thereof.

The control unit 202 can be implemented in a number of different ways. For example, the control unit 202 can be a processor, an application specific integrated circuit (ASIC), an embedded processor, a microprocessor, a hardware control logic, a hardware finite state machine (FSM), a digital signal processor (DSP), or a combination thereof. The control unit 202 can execute software and/or instructions to provide the intelligence of the robotic system 100.

The control unit 202 can be operably coupled to the user interface 210 to provide a user with control over the control unit 202. The user interface 210 can be used for communication between the control unit 202 and other functional units in the robotic system 100. The user interface 210 can also be used for communication that is external to the robotic system 100. The user interface 210 can receive information from the other functional units or from external sources, or can transmit information to the other functional units or to external destinations. The external sources and the external destinations refer to sources and destinations external to the robotic system 100.

The user interface 210 can be implemented in different ways and can include different implementations depending on which functional units or external units are being interfaced with the user interface 210. For example, the user interface 210 can be implemented with a pressure sensor, an inertial sensor, a microelectromechanical system (MEMS), optical circuitry, waveguides, wireless circuitry, wireline circuitry, application programming interface, or a combination thereof.

The storage unit 204 can store the software instructions, master data, tracking data or a combination thereof. For illustrative purposes, the storage unit 204 is shown as a single element, although it is understood that the storage unit 204 can be a distribution of storage elements. Also for illustrative purposes, the robotic system 100 is shown with the storage unit 204 as a single hierarchy storage system, although it is understood that the robotic system 100 can have the storage unit 204 in a different configuration. For example, the storage unit 204 can be formed with different storage technologies forming a memory hierarchal system including different levels of caching, main memory, rotating media, or off-line storage.

The storage unit 204 can be a volatile memory, a nonvolatile memory, an internal memory, an external memory, or a combination thereof. For example, the storage unit 204 can be a nonvolatile storage such as non-volatile random access memory (NVRAM), Flash memory, disk storage, or a volatile storage such as static random access memory (SRAM). As a further example, storage unit 204 can be a non-transitory computer medium including the non-volatile memory, such as a hard disk drive, NVRAM, solid-state storage device (SSD), compact disk (CD), digital video disk (DVD), or universal serial bus (USB) flash memory devices. The software can be stored on the non-transitory computer readable medium to be executed by a control unit 202.

The storage unit 204 can be operably coupled to the user interface 210. The user interface 210 can be used for communication between the storage unit 204 and other functional units in the robotic system 100. The user interface 210 can also be used for communication that is external to the robotic system 100. The user interface 210 can receive information from the other functional units or from external sources, or can transmit information to the other functional units or to external destinations. The external sources and the external destinations refer to sources and destinations external to the robotic system 100.

Similar to the discussion above, the user interface 210 can include different implementations depending on which functional units or external units are being interfaced with the storage unit 204. The user interface 210 can be implemented with technologies and techniques similar to the implementation of the user interface 210 discussed above.

In some embodiments, the storage unit 204 is used to further store and provide access to processing results, predetermined data, thresholds, or a combination thereof. For example, the storage unit 204 can store the master data that includes descriptions of the one or more target objects 112 (e.g., boxes, box types, cases, case types, products, and/or a combination thereof). In one embodiment, the master data includes dimensions, predetermined shapes, templates for potential poses and/or computer-generated models for recognizing different poses, a color scheme, an image, identification information (e.g., bar codes, quick response (QR) codes, logos, and the like), expected locations, an expected weight, and/or a combination thereof, for the one or more target objects 112 expected to be manipulated by the robotic system 100.

In some embodiments, the master data includes manipulation-related information regarding the one or more objects that can be encountered or handled by the robotic system 100. For example, the manipulation-related information for the objects can include a center-of-mass location on each of the objects, expected sensor measurements (e.g., for force, torque, pressure, and/or contact measurements), corresponding to one or more actions, maneuvers, or a combination thereof.

The communication unit 206 can enable external communication to and from the robotic system 100. For example, the communication unit 206 can enable the robotic system 100 to communicate with other robotic systems or units, external devices, such as an external computer, an external database, an external machine, an external peripheral device, or a combination thereof, through a communication path 218, such as a wired or wireless network.

The communication path 218 can span and represent a variety of networks and network topologies. For example, the communication path 218 can include wireless communication, wired communication, optical communication, ultrasonic communication, or the combination thereof. For example, satellite communication, cellular communication, Bluetooth, Infrared Data Association standard (IrDA), wireless fidelity (WiFi), and worldwide interoperability for microwave access (WiMAX) are examples of wireless communication that can be included in the communication path 218. Cable, Ethernet, digital subscriber line (DSL), fiber optic lines, fiber to the home (FTTH), and plain old telephone service (POTS) are examples of wired communication that can be included in the communication path 218. Further, the communication path 218 can traverse a number of network topologies and distances. For example, the communication path 218 can include direct connection, personal area network (PAN), local area network (LAN), metropolitan area network (MAN), wide area network (WAN), or a combination thereof. The robotic system 100 can transmit information between the various units through the communication path 218. For example, the information can be transmitted between the control unit 202, the storage unit 204, the communication unit 206, the I/O device 208, the actuation devices 212, the transport motors 214, the sensor units 216, or a combination thereof.

The communication unit 206 can also function as a communication hub allowing the robotic system 100 to function as part of the communication path 218 and not limited to be an end point or terminal unit to the communication path 218. The communication unit 206 can include active and passive components, such as microelectronics or an antenna, for interaction with the communication path 218.

The communication unit 206 can include a communication interface. The communication interface can be used for communication between the communication unit 206 and other functional units in the robotic system 100. The communication interface can receive information from the other functional units or from external sources, or can transmit information to the other functional units or to external destinations. The external sources and the external destinations refer to sources and destinations external to the robotic system 100.

The communication interface can include different implementations depending on which functional units are being interfaced with the communication unit 206. The communication interface can be implemented with technologies and techniques similar to the implementation of the control interface.

The I/O device 208 can include one or more input sub-devices and/or one or more output sub-devices. Examples of the input devices of the I/O device 208 can include a keypad, a touchpad, soft-keys, a keyboard, a microphone, sensors for receiving remote signals, a camera for receiving motion commands, or any combination thereof to provide data and communication inputs. Examples of the output device can include a display interface. The display interface can be any graphical user interface such as a display, a projector, a video screen, and/or any combination thereof.

The control unit 202 can operate the I/O device 208 to present or receive information generated by the robotic system 100. The control unit 202 can operate the I/O device 208 to present information generated by the robotic system 100. The control unit 202 can also execute the software and/or instructions for the other functions of the robotic system 100. The control unit 202 can further execute the software and/or instructions for interaction with the communication path 218 via the communication unit 206.

The robotic system 100 can include physical or structural members, such as robotic manipulator arms, that are connected at joints for motion, such as rotational displacement, translational displacements, or a combination thereof. The structural members and the joints can form a kinetic chain configured to manipulate an end-effector, such as a gripping element, to execute one or more task, such as gripping, spinning, or welding, depending on the use or operation of the robotic system 100. The robotic system 100 can include the actuation devices 212, such as motors, actuators, wires, artificial muscles, electroactive polymers, or a combination thereof, configured to drive, manipulate, displace, reorient, or a combination thereof, the structural members about or at a corresponding joint. In some embodiments, the robotic system 100 can include the transport motors 214 configured to transport the corresponding units from place to place.

The robotic system 100 can include the sensor units 216 configured to obtain information used to execute tasks and operations, such as for manipulating the structural members or for transporting the robotic units. The sensor units 216 can include devices configured to detect or measure one or more physical properties of the robotic system 100, such as a state, a condition, a location of one or more structural members or joints, information about objects or surrounding environment, or a combination thereof. As an example, the sensor units 216 can include imaging devices, system sensors, contact sensors, and/or any combination thereof.

In some embodiments, the sensor units 216 include one or more imaging devices 222. The imaging devices 222 are devices configured to detect and image the surrounding environment. For example, the imaging devices 222 can include 2-dimensional cameras, 3-dimensional cameras, both of which can include a combination of visual and infrared capabilities, lidars, radars, other distance-measuring devices, and other imaging devices. The imaging devices 222 can generate a representation of the detected environment, such as a digital image or a point cloud, used for implementing machine/computer vision for automatic inspection, robot guidance, or other robotic applications. As described in further detail below, the robotic system 100 can process the digital image, the point cloud, or a combination thereof via the control unit 202 to identify the target object 112 of FIG. 1, a pose of the target object 112 of, or a combination thereof. For manipulating the target object 112, the robotic system 100 can capture and analyze an image of a designated area, such as inside the truck, inside the container, or a pickup location for objects on the conveyor belt, to identify the target object 112 and the object source 114 of FIG. 1 thereof. Similarly, the robotic system 100 can capture and analyze an image of another designated area, such as a drop location for placing objects on the conveyor belt, a location for placing objects inside the container, or a location on the pallet for stacking purposes, to identify the task location 116 of FIG. 1.

In some embodiments, the sensor units 216 can include system sensors 224. The system sensors 224 can monitor the robotic units within the robotic system 100. For example, the system sensors 224 can include units or devices to detect and monitor positions of structural members, such as the robotic arms and the end-effectors, corresponding joints of robotic units or a combination thereof. As a further example, the robotic system 100 can use the system sensors 224 to track locations, orientations, or a combination thereof of the structural members and the joints during execution of the task. Examples of the system sensors 224 can include accelerometers, gyroscopes, or position encoders.

In some embodiments, the sensor units 216 can include the contact sensors 226, such as pressure sensors, force sensors, strain gauges, piezoresistive/piezoelectric sensors, capacitive sensors, elastoresistive sensors, torque sensors, linear force sensors, other tactile sensors, and/or any other suitable sensors configured to measure a characteristic associated with a direct contact between multiple physical structures or surfaces. For example, the contact sensors 226 can measure the characteristic that corresponds to a grip of the end-effector on the target object 112 or measure the weight of the target object 112. Accordingly, the contact sensors 226 can output a contact measure that represents a quantified measure, such as a measured force or torque, corresponding to a degree of contact or attachment between the gripping element and the target object 112. For example, the contact measure can include one or more force or torque readings associated with forces applied to the target object 112 by the end-effector.

### Suitable Object-Gripping Systems

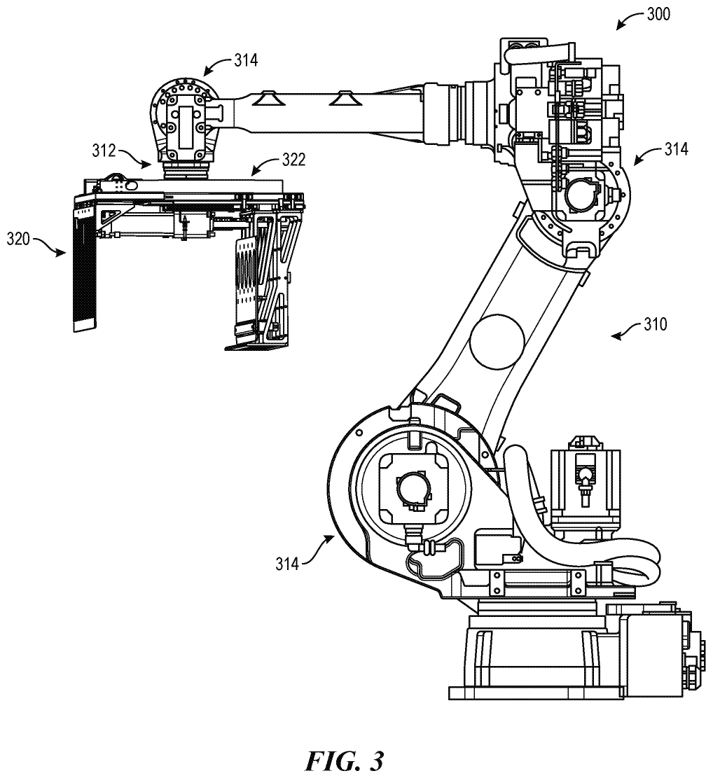

FIG. 3 is an illustration of a robotic unit 300 (e.g., one of the robotic units, such as a palletizer unit, a devanning unit, a picker unit, etc., described above for FIG. 1) configured in accordance with some embodiments of the present technology. In the illustrated embodiment, the robotic unit 300 includes a robotic arm 310 and an end-of-arm tool 320 (sometimes also referred to herein as an “end effector,” an “object-gripping mechanism,” an “object-gripping assembly,” a “gripping assembly,” a “grasping mechanism,” an “object gripper,” a “gripper,” and/or a “gripping head”) carried by the robotic arm 310. As illustrated in FIG.3, the robotic arm 310 can include a first flange 312 and one or more joints 314 (three shown), while the end-of-arm tool 320 includes a second flange 322 operably couplable to the first flange 312 of the robotic arm 310. When joined together, the first and second flanges 312, 322 can establish both a physical connection and one or more communicative connections (e.g., electrical connections, fluid connections, or other suitable communicative connections). The physical connections allow the robotic arm 310 to carry the end-of-arm tool 320 while the communicative connections allow the end-of-arm tool 320 to be controlled through a connection to the robotic arm 310.

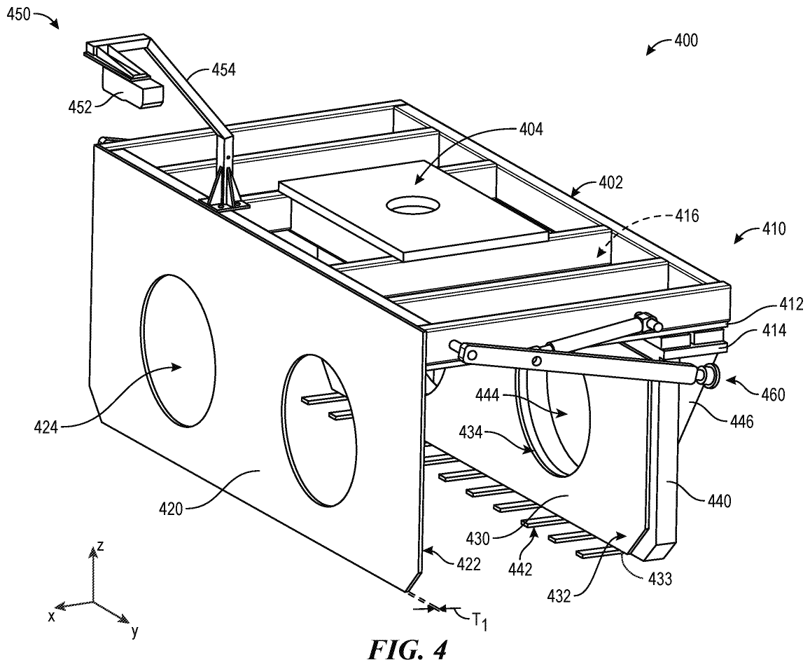

The robotic unit 300 can be configured to clamp, pick up, grip, transport, release, load, and/or unload various types or categories of objects. For example, in the illustrated embodiment, the one or more joints 314 allow the robotic arm 310 to controllably position the end-of-arm tool 320 over and/or adjacent to one or more target objects (e.g., the target object 112 discussed above with respect to FIG. 1). Once positioned, the end-of-arm tool 320 can be operated to grip the target object(s). The one or more joints 314 also then the robotic arm 310 to controllably position the end-of-arm tool 320 to move the target object(s) between locations (e.g., between a pick-up location and a drop-off location). Once the end-of-arm tool 320 is positioned over a desired location, the end-of-arm tool 320 can be operated to release the target object(s). Additional details on the operation of the end-of-arm tool 320 are provided below with respect to FIGS. 4-12.

FIG. 4 is a partially schematic illustration of an end-of-arm tool 400 configured in accordance with some embodiments of the present technology. In the illustrated embodiment, the end-of-arm tool 400 (sometimes also referred to herein as an “end effector,” an “object-gripping mechanism,” an “object-gripping assembly,” a “gripping assembly,” a “grasping mechanism,” an “object gripper,” a “gripper,” a “gripping head” and/or the like) includes a frame 402 as well as an actuator system 410, a first clamping component 420, a second clamping component 430, and a third clamping component 440 each coupled to (and carried by) the frame 402. The end-of-arm tool 400 can be coupled to a robotic arm (e.g., the robotic arm 310 of FIG. 3) and/or another suitable component via a connection flange 404 on an upper surface of the frame 402.

In various embodiments, the actuator system 410 can be coupled to the first clamping component 420, the second clamping component 430, and/or the third clamping component 430 to move the first, second, and/or third clamping components 420, 430, 440 independently along a transverse axis (e.g., the x-axis and/or at least partially orthogonal (or orthogonal) to the longitudinal axis) of the frame 402 to grip and/or release one or more target objects. For example, in the illustrated embodiment, the actuator system includes a track 412; two or more carriages 414 (one labeled) coupled between the second clamping component 430 and the track 412, as well as between the third clamping component 440 and the track 412; and one or more drivers 416 operably coupled to the carriages 414 to drive their motion along the track 412. As a result, the actuator system 410 can drive motion of the second and third clamping components 430, 440 along the transverse axis while the first clamping component 420 remains in place. The fixed coupling between the first clamping component 420 and the frame 402 can simplify the operation of the end-of-arm tool 400. However, it will be understood that, in some embodiments, the actuator system 410 is operably coupled to the first clamping component 420 in addition to (or instead of) the second and third clamping components 430, 440.

In various other embodiments, the actuator system 410 can include additional, or alternative, components to move the first, second, and/or third clamping components 420, 430, 440. For example, the actuator system 410 can include an extendable component (e.g., a telescoping component, piston, a linear actuator, and/or the like) in place of, or in addition to, the track 412 and carriages 414 described above. Additionally, or alternatively, the actuator system 410 can include electric track actuators, coiled actuators, fixed belt actuators, lead screw actuators, and/or any other suitable mechanism to move the first, second, and/or third clamping components 420, 430, 440 in accordance with the systems and methods described herein.

In the illustrated embodiment, the first clamping component 420 is a rigid, thin material coupled to a peripheral edge of the frame 402. As a result, the first clamping component 420 (sometimes also referred to herein as an “external clamping component,” a “clamping plate,” and/or the like) defines a constant (e.g., unchanging) edge of the clamping mechanism on the end-of-arm tool 400 for reference during a packing operation. As further illustrated in FIG. 4, the first clamping component 420 includes a first clamping surface 422 oriented (e.g., facing, directed) toward the second clamping component 430 and one or more first openings 424 (two shown). In some embodiments, the first clamping surface 422 can include a gripping substrate (e.g., a high friction material such as silicon, rubber, a textured surface, and/or the like) to help grip one or more target objects. The first opening(s) 424 can reduce the weight of the first clamping component 420, increasing the maneuverability of the end-of-arm tool 400 and/or reducing the strain on a robotic system using the end-of-arm tool 400.

As discussed in more detail below, during a packing operation, the first clamping component 420 abuts existing objects (e.g., previously placed objects, container walls and/or barriers, and/or the like) while the second and third clamping components 430, 440 release the target object(s) at the destination. As a result, the thickness T₁ (along the x-axis) of the first clamping component 420 imposes a lower limit on how tightly the target object(s) can be packed at the destination. Because the thickness T₁ imposes a limit on how tightly the target object(s) can be packed, it is beneficial for the first clamping component 420 to be as thin as possible while providing the necessary rigidity to grip the target object(s). In various embodiments, the thickness T₁ can be between about 1 millimeter (mm) and about 3 centimeters (cm).

The second clamping component is carried by the frame 402 through the actuator system 410. Similar to the first clamping component 420, the second clamping component 430 430 (sometimes also referred to herein as an “internal clamping component,” a “clamping plate,” an “active clamping component,” and/or the like) includes a second clamping surface 432 oriented (e.g., facing, directed) toward the first clamping component 420 and one or more second openings 434 (two shown). The second clamping surface 432 can include a gripping substrate to help grip the target object(s), while the second opening(s) 434 can reduce the weight of the second clamping component 430. Further, as discussed above, the second clamping component 430 is operably coupled to one or more of the carriages of the actuator system 410 to move the second clamping component 430 along the transverse axis (e.g., toward and away from the first clamping component 420). As a result, the first and second clamping surfaces 422, 432 can engage opposing (e.g., opposite) side surfaces of the target object(s), allowing the end-of-arm tool 400 to lift and transport the target object(s).

The third clamping component 440 provides optional, additional support to the target object(s) engaged by the end-of-arm tool 400. In the illustrated embodiment, the third clamping component 440 is carried by the frame 402 through the actuator system 410 peripheral to the second clamping component 430 along the transverse axis (e.g., the x-axis) of the frame 402 (sometimes also referred to herein as peripheral to the second clamping component 430 with respect to the first clamping component 420). The third clamping component 440 includes one or more extension portions 442 (sometimes also referred to as “object support components,” “lifting portions,” “protrusions,” “object-lifting components,” and/or the like) that project toward the first clamping component 420 and one or more openings 444 (one labeled, two illustrated). Further, when the third clamping component 440 abuts the second clamping component 430 (e.g., as illustrated), the extension portions 442 extend beneath a lower edge 433 of the second clamping component 430 and beyond the second clamping surface 432. As a result, the extension portions 442 can engage or otherwise support a lower surface of the target object(s) engaged by the first and second clamping surfaces 422, 432. Additionally, or alternatively, the third clamping component 440 can add stability to the end-of-arm tool 400 by increasing the rigidity of the movable side of the end-of-arm tool 400. The additional support and/or stability can help stabilize the target object(s) during transportation and/or allow the end-of-arm tool 400 to lift and transport heavier objects.

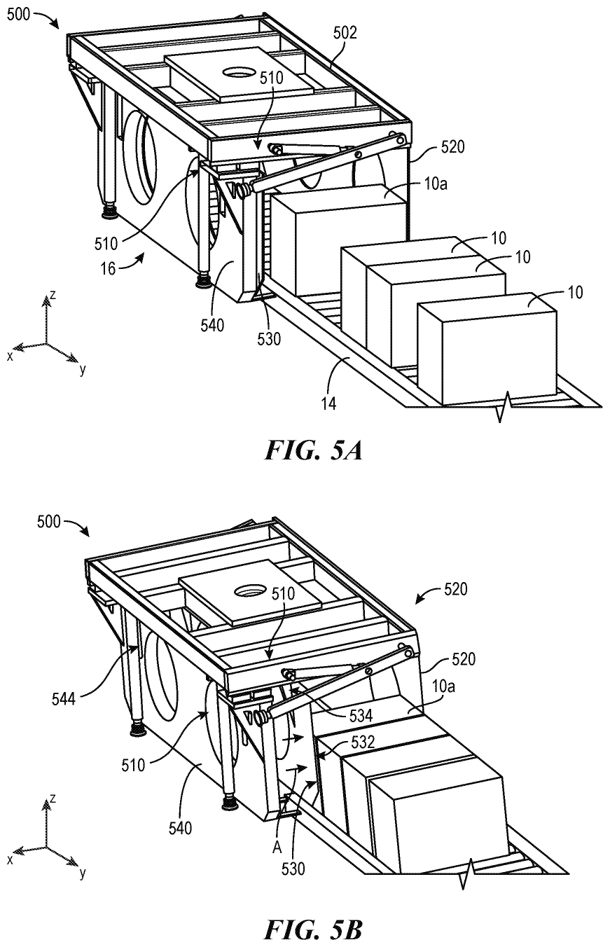

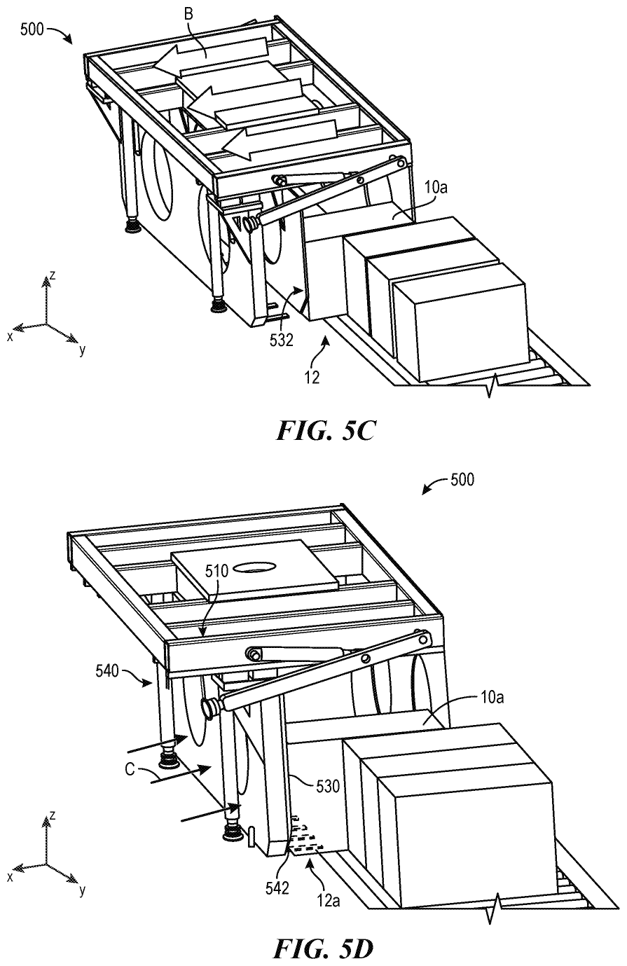

In the illustrated embodiment, the third clamping component 440 includes one or more bracing bracket(s) 446 (one illustrated in FIG. 4) that can facilitate the coupling between the third clamping component 440 and the carriages 414 of the actuator system 410. For example, the bracing bracket(s) 446 can help spread the force applied to the third clamping component 440 along a larger vertical portion of the third clamping component 440 (e.g., spreading the force along the z-axis). As a result, the bracing bracket(s) 446 can help ensure that a lower edge of the third clamping component 440 moves at the same rate as an upper edge of the third clamping component 440. In some embodiments, for example as discussed in more detail below, the second clamping component 430 includes one or more bracing brackets that can be generally similar to the bracing bracket 446 on the third clamping component 440 (e.g., as illustrated below with respect to FIG. 5B).

As further illustrated in FIG. 4, the end-of-arm tool 400 can include a sensor system 450 and one or more retractable suction grippers 460 (one shown). In the illustrated embodiment, the sensor system includes a sensor unit 452 and an arm 454 coupling the sensor unit 452 to the frame 402. The sensor unit 452 can include any of the sensor units 216 described above with reference to FIG. 2 to measure a state of the end-of-arm tool 400 and/or a broader robotic system; one or more parameters of one or more target objects (e.g., dimensions, shapes, object types, and/or the like), a pick-up location, a drop-off location and/or destination, and/or transportation pathway; and/or the like. In various other embodiments, the sensor system 450 can include one or more additional components, can be coupled to various other locations on the end-of-arm tool 400 (or in a broader robotic system), and/or can omit the arm 454. Purely by way of example, the sensor system 450 can include one or more sensor units 452 that area each coupled (or connected) to the frame 402 without the arm 454. As discussed in more detail below, the retractable suction grippers 460 can allow the end-of-arm tool 400 to grip, transport, and place a divider (e.g., a slip sheet or other suitable divider) between layers at a destination and/or to remove a divider while unpacking a shipping unit.

FIGS. 5A-5D are partially schematic illustrations of an end-of-arm tool 500 gripping a target object 10a (FIG. 5B) in accordance with some embodiments of the present technology. As illustrated in FIG. 5A, the end-of-arm tool 500 is generally similar to the end-of-arm tool 400 discussed above with reference to FIG. 4. For example, the end-of-arm tool 500 includes a frame 502, as well as an actuator system 510 and a first clamping component 520 coupled to the frame 502. The end-of-arm tool 500 also includes a second clamping component 530 coupled to the actuator system 510 (and the frame 502 therethrough) opposite the first clamping component 520 and a third clamping component 540 coupled to the actuator system 510 peripheral to the second clamping component 530. As further illustrated in FIG. 5A, the end-of-arm tool 500 can be positioned (e.g., by a robotic unit such as the robotic unit 300 of FIG. 3) to grasp, grip, and/or otherwise engage and move target objects 10 from a pick-up location 16 on a conveyor system 14 (or any other suitable pick-up location).

As further illustrated in FIG. 5A, the gripping process can begin by aligning the first clamping component 520 with a side surface of a first target object 10a. When aligned, the first clamping component 520 can be adjacent to (or in contact with) the side surface to reduce (or minimize) the distance the first target object 10a will be pushed as the end-of-arm tool 500 grips (e.g., clamps, engages, and/or otherwise secures) the first target object 10a.

As illustrated in FIG. 5B, after the first clamping component 520 is aligned, the actuator system 510 can move the second clamping component 530 along a first motion path A (e.g., along the transverse axis of the end-of-arm tool 500). As the second clamping component 530 moves, the second clamping surface 532 can engage with a side surface of the first target object 10a and push the first target object 10a into contact with the first clamping component 520. As a result, the first and second clamping components 520, 530 are engaged with opposing side surfaces of the first target object 10a thereby allowing the end-of-arm tool 500 to move and/or lift the first target object 10a.

As further illustrated in FIG. 5B, the second clamping component 530 can include one or more bracing brackets 534 (one illustrated in FIG. 5B). Similar to the bracing bracket 446 discussed above with reference to FIG. 4, the bracing bracket(s) 534 on the second clamping component 530 can help ensure that the entirety of the second clamping component 530 moves at the same rate, thereby helping ensure that an even clamping pressure is applied to the side surfaces of the first target object 10a. (e.g., rather than applying more pressure along the upper edge of the first target object 10a). Further, in the illustrated embodiment, the third clamping component 540 includes one or more openings 544 (two illustrated, one labeled in FIG. 5B). The bracing bracket(s) 534 on the second clamping component 530 can each nest with one of the openings 544 on the third clamping component 540 to allow the third clamping component 540 to directly abut the second clamping component 530 and provide maximum extra support for the first target object 10a and/or stability to the end-of-arm tool 500.

In some embodiments, the first and second clamping components 520, 530 engage the first target object 10a with sufficient force and/or security to move the first target object 10a without support from the third clamping component 540 (FIG. 5A). For example, when the target objects 10 are relatively light, the end-of-arm tool 500 can operate without the third clamping component 540 to accelerate the process of gripping and moving the target objects 10. In other embodiments, after the first and second clamping components 520, 530 are engaged with the side surfaces of the first target object 10a, the end-of-arm tool 500 can move to expose at least a portion of the lower surface of the first target object 10a adjacent to the second clamping component 530. The exposed portion of the lower surface can then be engaged and/or supported by the extension portions of the third clamping component 540 (FIG. 5A).

For example, in the embodiment illustrated in FIGS. 5C and 5D, the end-of-arm tool 500 can move laterally (or mostly laterally) along a second motion path B (FIG. 5C) to pull the first target object 10a partially off the conveyor system 14 to expose a portion of the lower surface 12a of the first target object 10a. Then, the actuator system 510 (FIG. 5D) can move the third clamping component 540 along a third motion path C until the extension portions 542 engage the lower surface 12a of the first target object 10a and/or until the third clamping component 540 abuts the second clamping component 530 (FIG. 5D). As a result, the third clamping component 540 can help support the first target object 10a and/or can help stabilize the end-of-arm tool 500 during transportation. The added support and/or stability can be especially helpful when transporting heavier target objects and/or large volumes of target objects at once.

It will be understood that, although the second motion path B (FIG. 5C) is illustrated and discussed herein as a lateral motion path, the technology is not so limited. In various embodiments, the second motion path B can have a vertical component in addition to the lateral component and/or can be completely vertical. Purely by way of example, the second motion path can be completely vertical when the end-of-arm tool 500 is deployed in an environment with low amounts of lateral clearance around the pick-up location 16 (FIG. 5A).

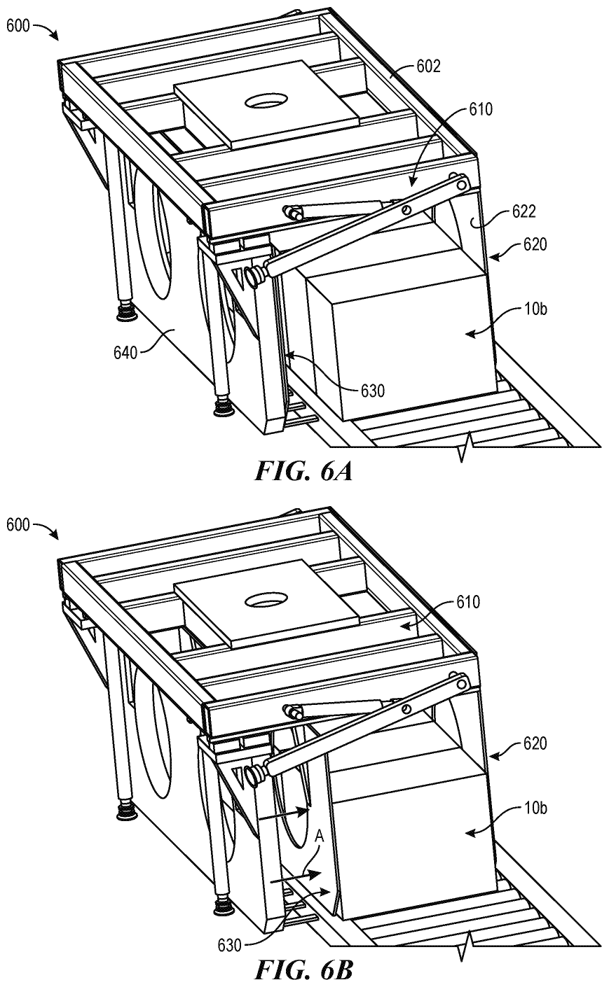

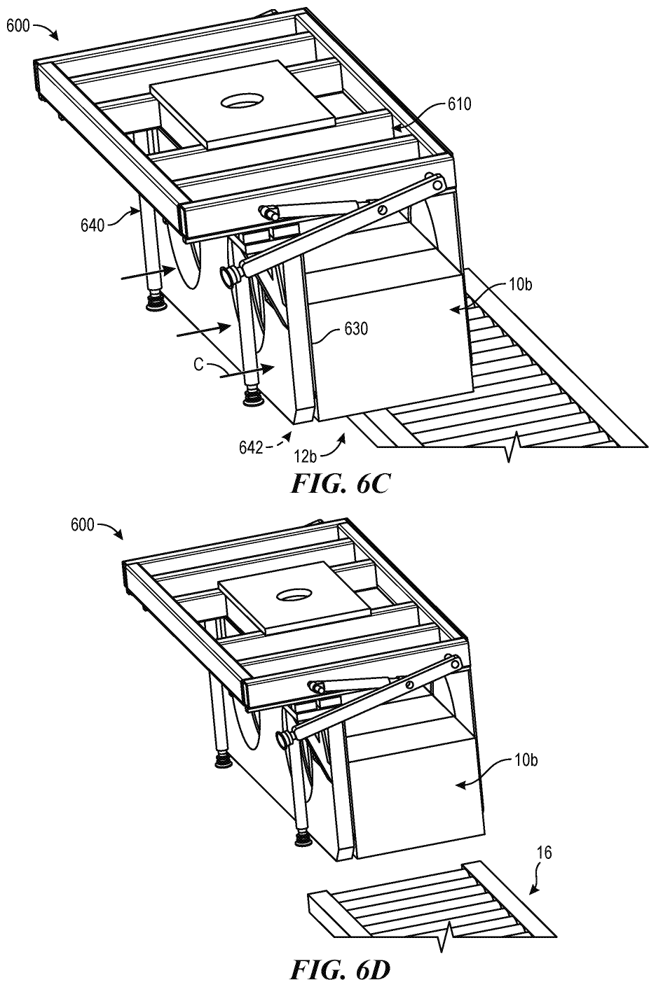

FIGS. 6A-6D are partially schematic illustrations of an end-of-arm tool 600 gripping a plurality of target objects in accordance with some embodiments of the present technology. As illustrated in FIG. 6A, the end-of-arm tool 600 is generally similar to the end-of-arm tools 400, 500 discussed above with reference to FIGS. 4 and 5A. For example, the end-of-arm tool 600 includes a frame 602, as well as an actuator system 610 and a first clamping component 620 coupled to the frame 602. The end-of-arm tool 600 also includes a second clamping component 630 coupled to the actuator system 610 opposite the first clamping component 620 and a third clamping component 640 coupled to the actuator system 610 peripheral to the second clamping component 630.

Further, as illustrated in FIGS. 6A-6C, the gripping process for a plurality of target objects 10b is generally similar to the gripping process for the first target object 10a discussed above with reference to FIGS. 5A-5D. For example, As illustrated in FIG. 6A the gripping process can begin by aligning the first clamping component 620 with opposing side surfaces of the plurality of target objects 10b. As aligned, the first clamping surface 622 can be adjacent to and/or in contact with the side surfaces of the plurality of target objects 10b. As illustrated in FIG. 6B, the actuator system 610 can then move the second clamping component 630 along the first motion path A until the first and second clamping components 620, 630 are engaged with side surfaces of the plurality of target objects 10b. As illustrated in FIG. 6C, the end-of-arm tool 600 can then move (e.g., along the second motion path B of FIG. 5C or any other suitable motion path) to expose at least a portion of a lower surface 12b of the plurality of target objects. Once exposed, the actuator system 610 can move the third clamping component 640 along the third motion path C until the extension portions 642 engage the lower surface 12b and/or the third clamping component 640 abuts the second clamping component 630. As illustrated in FIG. 6D, once the plurality of target objects 10b have been fully engaged, the end-of-arm tool 600 can lift away from (or otherwise move away from) the pick-up location 16.

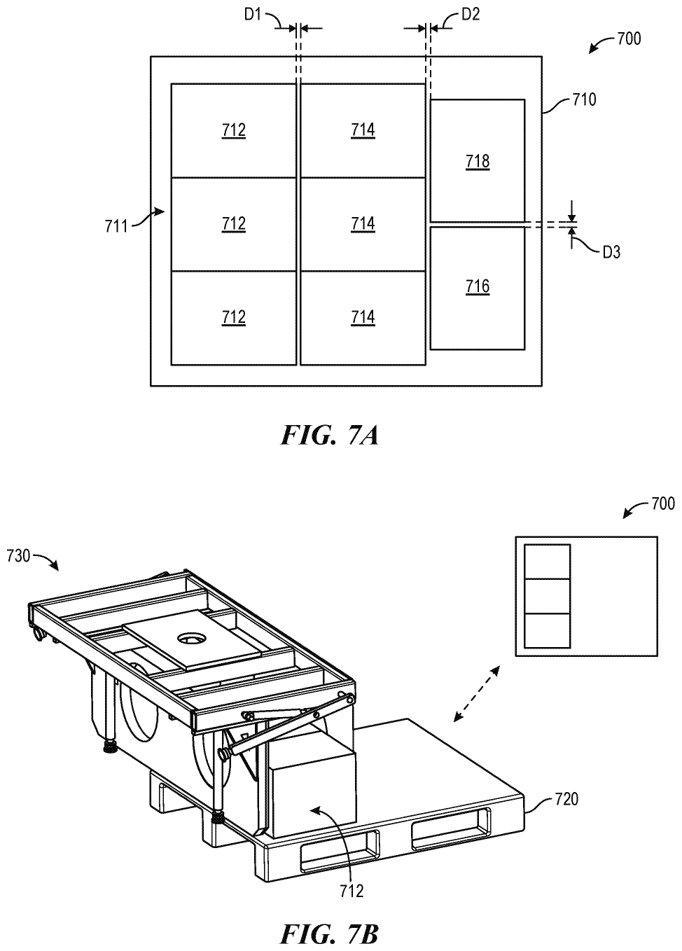

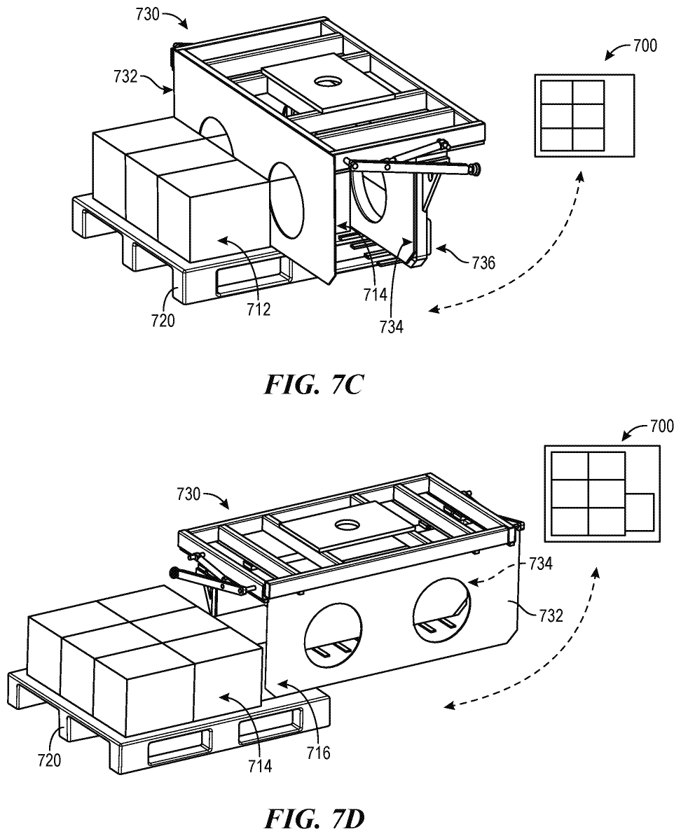

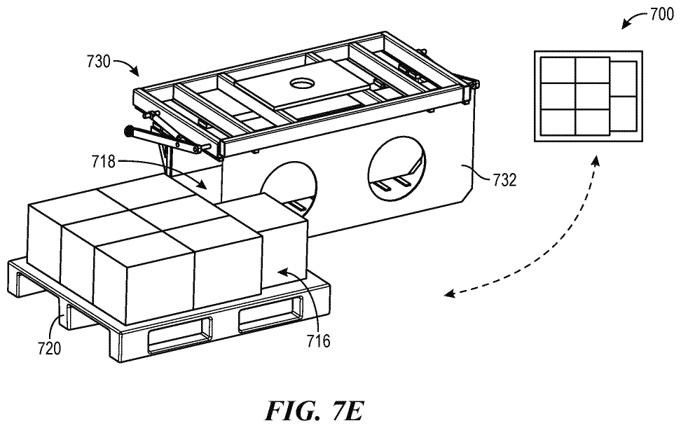

FIG. 7A is a partially schematic top view of a plan 700 for a packing operation in accordance with some embodiments of the present technology. The plan 700 can be implemented to load target objects 711 (e.g., boxes of consumer goods and/or any other suitable item) onto a shipping unit 710 (e.g., a pallet, a crate, carton, shipping container, and the like, and/or of any other suitable unit such as a warehouse cart, truck bed, and the like). In the illustrated embodiment, the target objects 711 include four groups: a first group of target objects 712, a second group of target objects 714, a third target object 716, and a fourth target object 718.

As discussed in more detail below, the target objects 711 can be placed in the shipping unit 710 sequentially by an end-of-arm tool similar to those discussed above with reference to FIGS. 4-6D. As a result, there is a first distance D₁ between the first and second groups of target objects 712, 714; a second distance D₂ between the second group of target objects 714 and each of the third and fourth target objects 716, 718; and a third distance D₃ between the third and fourth target objects 716, 718. The first, second, and third distances D₁-D₃ are each defined by the thickness of the external clamping component (e.g., the thickness T₁ of the first clamping component 420 in FIG. 4) and/or any additional space resulting from the alignment of the end-of-arm tool while placing the target objects 711 (e.g., extra space to allow the external clamping component to depart after placing the target objects, a margin of error, and the like). In some embodiments, the first, second, and third distances D₁-D₃ are all equal. For example, when the first, second, and third distances D₁-D₃ are defined only by the thickness of the external clamping component, the first, second, and third distances D₁-D₃ are each minimized and equal.

FIGS. 7B-7E are partially schematic illustrations of an end-of-arm tool 730 placing target objects on a pallet 720 in accordance with the plan 700 of FIG. 7A in accordance with some embodiments of the present technology. As illustrated in FIG. 7A, the placing process (sometimes also referred to herein as a packing process) can begin with the end-of-arm tool 730 placing the first group of target objects 712 on the pallet 720 (a shipping pallet in the illustrated embodiment). Because the pallet 720 does not have any sidewalls or other surface features, the end-of-arm tool 730 does not have any constraints while placing the first group of target objects 712. Instead, the end-of-arm tool 730 can carefully align the placement according to the plan 700, which will impact the placement of the remaining target objects.

As illustrated in FIG. 7B, the end-of-arm tool 730 can then place the second group of target objects 714 adjacent to the first group of target objects 712. In the illustrated embodiment, the end-of-arm tool 730 is generally similar to the end-of-arm tools 400, 500, 600 discussed above with reference to FIGS. 4-6D. For example, the end-of-arm tool 730 includes a first clamping component 732, a second clamping component 734 opposite the first clamping component 732, and a third clamping component 736 peripheral to the second clamping component 734. During transportation, the first clamping component 732 engages a first side of the second group of target objects 714, the second clamping component 734 engages a second side of the second group of target objects 714 opposite the first side, and the third clamping component helps support at least a portion of the lower surface of the second group of target objects 714. Further, similar to the first clamping component 420 discussed above with reference to FIG. 4, the first clamping component 732 can be relatively thin, thereby making the first clamping component 732 useful for densely placing the target objects on the pallet 720.

For example, as illustrated in FIG. 7C, the end-of-arm tool 730 can position the first clamping component 732 between the first and second groups of target objects 712, 714 while placing the second group of target objects 714. As a result, the gap between the first and second groups of target objects 712, 714 can be generally equal to the thickness of the first clamping component 732 (e.g., between about 1 mm and about 3 cm). After placing the second group of target objects 714, the second and third clamping components 734, 736 can move away from the first clamping component 732 and the end-of-arm tool 730 can move vertically to disengage the second group of target objects 714. As a result, the relatively small gap between the first and second groups of target objects 712, 714 is maintained.

In some embodiments, the third clamping component 736 is moved away from first clamping component 732 before the end-of-arm tool 730 approaches a placement position on the pallet 720. As a result, the extension portions on the third clamping component 736 can be disengaged from the target objects and moved out of the way while placing the target objects. In other embodiments, however, the second and third clamping components 734, 736 are moved away from the first clamping component 732 at the same time at the placement location.

As illustrated in FIGS. 7D and 7E, the end-of-arm tool 730 can then repeat the placement process for the third and fourth target objects 716, 718. In some embodiments, the orientation of the end-of-arm tool 730 with respect to the pallet 720 can remain the same for the remaining placing processes, resulting in a generally similar game between the second group of target objects 714 and each of the third and fourth target objects 716, 718. In various other embodiments, the orientation of the end-of-arm tool 730 can be rotated around a vertical axis (e.g., the z-axis of FIG. 4) between any step of the placing process. For example, in the embodiment illustrated in FIGS. 7D and 7E, the end-of-arm tool 730 has been rotated 90 degrees about the vertical axis. In some embodiments, the rotation allows the end-of-arm tool 730 to place the third and fourth target objects 716, 718 in contact with (or in close proximity to) the second group of target objects 714. However, the rotation can require a gap between the third and fourth target objects 716, 718 to accommodate the first clamping component 732 therebetween.

### Suitable Methods for Planning and Executing Packing Operations

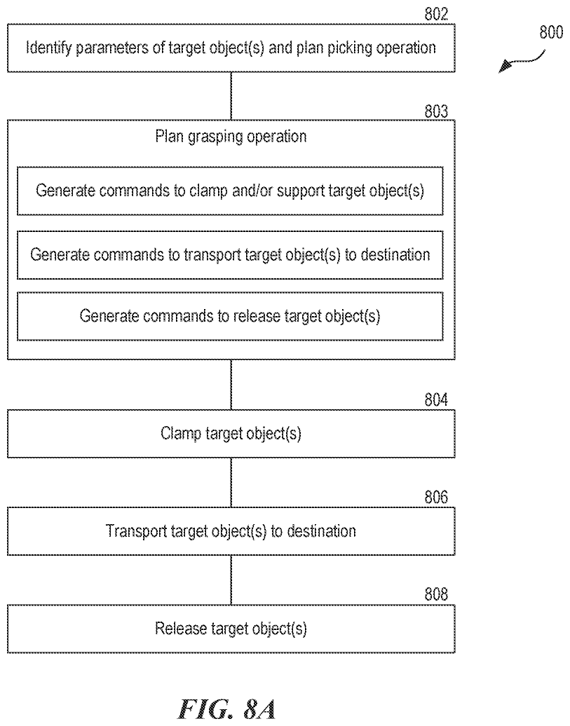

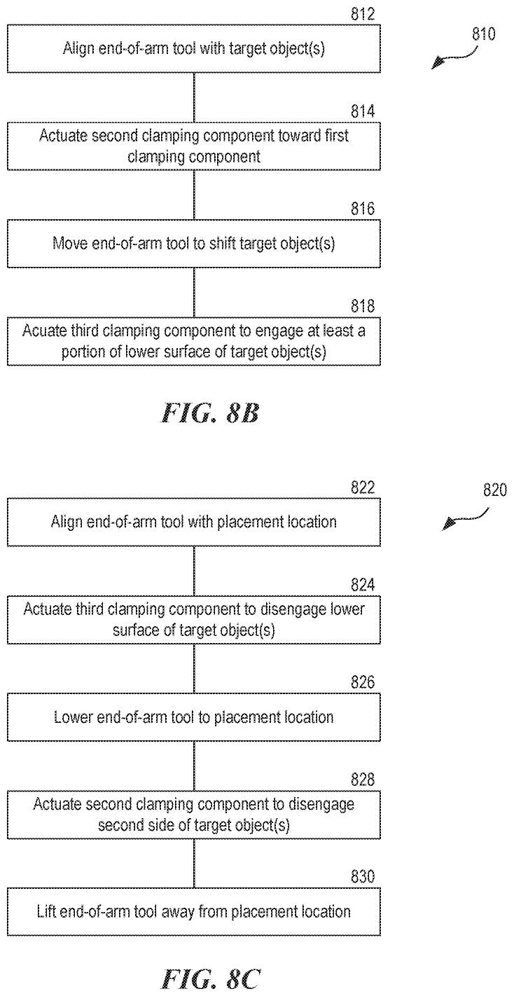

FIG. 8A is a flow diagram of a process 800 for a packing operation in accordance with some embodiments of the present technology. The process 800 can be executed by a controller on the end-of-arm tool itself and/or by an external controller (e.g., the controller 109 of FIG. 1 having the control unit 202 of FIG. 2).

The process 800 begins at block 802 by identifying one or more parameters of one or more target object(s) and planning a grasping operation. The parameters can include a length, width, height, weight, expected weight, weight distribution, expected weight distribution, wall strength, expected wall strength, rigidity, and/or any other suitable parameter. In some embodiments, the parameter(s) are identified by one or more sensors (e.g., sensor units 216 of FIG. 2 and/or imaging system 160 of FIG. 1). Alternatively, or additionally, the parameter(s) can be retrieved from a database (e.g., a cloud database or other suitable database) using a unique identifier (e.g., barcode, QR code, RFID and/or any other suitable identifier) on the target object(s).

As an illustrative example, the robotic system 100 can obtain image data (e.g., 2-dimensional and/or 3-dimensional representation of the object source 14) having the target object 112 and/or various objects in the surrounding environment. The robotic system 100 can identify the edges, the surface texture (e.g., images and/or characters printed on the surface of the objects), heights, or the like to identify candidate objects depicted in the image data. The robotic system 100 can compare the identified candidate objects and characteristics thereof (e.g., edge lengths, surface textures, etc.) to those of objects registered in the master data. Based on matching a registered object, the robotic system 100 can detect the object depicted in the image data based on identifying a type or an identifier for the depicted location and based on locating the depicted object.

At block 803, the process 800 includes planning a grasping operation based on the parameter(s) identified/detected at block 802, an environment surrounding the target object(s) at a picking location (e.g., in a conveyor belt and/or any other suitable location), and/or an environment at a placement location (e.g., in a pallet container or other shipping unit, on a warehouse cart, and/or any other suitable location). Planning the grasping operation can include: planning an approach for the end-of-arm tool (e.g., as illustrated in FIGS. 5A and 6A) that includes aligning the first clamping element with the target object(s), a starting distance between the first and second clamping elements, and the like; operations for engaging and gripping the target object(s) (via, e.g., clamping via the first and second clamping components, actuating the end-of-arm tool to expose a lower surface of the target object(s), supporting the lower surface of the target object(s) via the third clamping component, and the like); planning a travel path between the picking location and the placement location while avoiding contact with a surrounding environment; and planning a releasing operation (e.g., identifying a placement location, aligning the end-of-arm tool at the identified location, disengaging the third clamping component, lowering the end-of-arm tool into position, actuating the second clamping component to release the target object(s), and the like); planning a travel path away from the placement location (e.g., a departing trajectory), and/or any other suitable details. In some embodiments, planning the grasping operation includes generating commands for each stage of the grasping operation that can be executed by the end-of-arm tool and/or any controller coupled thereto to execute the grasping operation. Additionally, planning the grasping operation at block 803 can include generating commands for one or more components of the robotic system (e.g., the robotic system 100 of FIG. 1) and/or components thereof (e.g., the robotic unit 300 of FIG. 3, the end-of-arm tool 400 of FIG. 4, and the like) to execute to complete one or more of the operations discussed above. For example, as illustrated in FIG. 8A, planning the grasping operation at block 803 can include generating commands to clamp and/or support the target object(s), generating commands to transport the target object(s), generating commands to release the target object(s), and/or generating commands to depart from the placement location.

In planning the grasping operation, the process 800 can derive a grasping location on the target object(s) such that a side surface of the target object(s) is aligned with (or peripheral to) a longitudinal end of the first and second clamping components (e.g., as illustrated in FIGS. 5A-7E). The alignment can allow the end-of arm tool to place the target object(s) in close proximity to previously placed objects and/or barriers at the placement location. Further, the process 800 can plan a targeted clamping location and/or operation of the clamping elements (also referred to as a planned gripping location). For example, the process 800 can identify a starting location for the first clamping element and an expected travel distance for the second clamping element to engage the target object(s) therebetween. The plans can allow the robotic system 100 (and/or the end-of-arm tool therein) to operate at a faster speed, a lower sampling frequency for monitoring the feedback sensors, or similar settings for operating the clamping components, especially when the clamping components are outside of a threshold distance from the planned grip location. The robotic system 100 can then adjust the settings, such as the movement speed, the sampling sensitivity, or the like when the clamping components are closer to an expected clamping location (e.g., when the first and second clamping components are within a threshold distance of an expected engagement with the target object(s)).

At blocks 804-808, the process 800 then includes implementing the planned grasping operation. At block 804, the process 800 includes grasping the target object(s). Additional details on the grasping process are discussed below with respect to FIG. 8B. At block 806, the process 800 includes transporting the target object(s) from the picking location to a placement location along a motion path panned at block 803. In some embodiments, block 806 includes monitoring the environment during transportation to detect and avoid hazards and/or obstacles (e.g., humans and/or other robotics moving in the vicinity of the end-of-arm tool). At block 808, the process includes releasing the target object(s) at the placement location. Additional details on the placement process are discussed below with respect to FIG. 8C.

FIG. 8B is a flow diagram of a process 810 for picking one or more target objects during the packing operation at block 804 of FIG. 8A in accordance with some embodiments of the present technology. The process 800 can be executed by a controller on the end-of-arm tool itself and/or by an external controller (e.g., the controller 109 of FIG. 1 having the control unit 202 of FIG. 2). Further, each step of the process 810 can be planned at block 803 of FIG. 8A.

At block 812, the process 810 includes aligning the end-of-arm tool with the target object(s) at the pick-up location. As illustrated in FIGS. 5A and 6A, the alignment can include placing the first clamping component in contact with (or adjacent to) a first side surface of the target object(s) to reduce the travel of the second clamping component and/or reduce the distance the second clamping component must push the target object(s). Further, as discussed above, the alignment can include aligning a longitudinal end of the end-of-arm tool with (or generally with) a second side surface of the target object(s).

At block 814, the process 810 includes actuating the second clamping component the first clamping component, for example as illustrated in FIGS. 5B and 6B. The actuation can be driven by the actuator system under the control of the controller 109 of FIG. 1 and/or any other suitable component. As a result of the actuation, the second clamping component is brought into contact with a third side surface of the target object(s) opposite the first side surface and pushes the target object(s) into the first clamping component. In some embodiments, the process 810 can end after block 814 with the first and second clamping components engaging the target objects (e.g., without engaging the third clamping component). In other embodiments, the process 810 continues to block 816.

At block 816, the process 810 includes moving the end-of-arm tool to expose at least a portion of the lower surface of the target object(s), for example as illustrated in FIG. 5C. Block 816 can be executed by the robotic unit (e.g., the robotic unit 300 of FIG. 3) under the control of the controller 109 of FIG. 1 and/or any other suitable component. In various embodiments, the motion can be purely lateral (e.g., pulling the target object(s) partially off a conveyor belt or other pick-up location before adding support to the lower surface), partially vertical, and/or purely vertical (e.g., lifting the target object(s) in place). Further, in some embodiments, the process 810 can skip block 816 and move directly to block 818 (e.g., when a portion of the lower surface is already exposed and/or when the extension portions of the third clamping component are sufficiently thin).

At block 818, the process 810 includes actuating the third clamping component to engage the lower surface of the target object(s), for example as illustrated in FIGS. 5D and 6C. Similar to the process 810 at block 814, the actuation of the third clamping component can be driven by the actuator system under the control of the controller 109 of FIG. 1 and/or any other suitable component. Engaging the lower surface of the target object(s) can increase the stability of the target object(s) during transportation, which can be especially useful for heavy objects and/or rapid transportation.

FIG. 8C is a flow diagram of a process 820 for placing one or more target objects during the packing operation at block 808 of FIG. 8A in accordance with some embodiments of the present technology. The process 800 can be executed by a controller on the end-of-arm tool itself and/or by an external controller (e.g., the controller 109 of FIG. 1 having the control unit 202 of FIG. 2). Further, each step of the process 820 can be planned at block 803 of FIG. 8A.

At block 822, the process 820 includes aligning the end-of-arm tool with a placement location. The alignment can place the end-of-arm tool directly above and/or otherwise adjacent to the placement location. The alignment process can be executed by the robotic unit (e.g., the robotic unit 300 of FIG. 3) under the control of the controller 109 of FIG. 1 and/or any other suitable component. In some embodiments, the alignment is based on a planned placing location (e.g., the plan 700 of FIG. 7A). The alignment based on a plan for the placement can allow the end-of-arm tool to move quickly while grasping the target object(s). In some embodiments, the alignment is reactive to an analysis of the placement location as the end-of-arm tool approaches. For example, the sensor system 450 of FIG. 4 can obtain image data of the placement location as the end-of-arm tool approaches that the controller 109 of FIG. 1 and/or any other suitable component uses to determine an appropriate placement location for the target object(s). The reactive alignment can allow the end-of-arm tool to be used in conjunction with one or more other components (e.g., a second end-of-arm tool, a human, another robotic system, and the like).

At block 824, the process 820 includes actuating the third clamping component to disengage the lower surface of the target object(s). The actuation can be driven by the actuator system under the control of the controller 109 of FIG. 1 and/or any other suitable component. As a result of the actuation, the extension portions of the third clamping component can be out of the way when the end-of-arm tool releases the target object(s) at the placement location. In some embodiments, the process 820 can implement block 824 before (or simultaneously with) block 822 to disengage the lower surface of the target object(s) before aligning the end-of-arm tool with the placement location (or while aligning the end-of-arm tool with the placement location). In some embodiments, the process 820 can skip block 824 (e.g., when the third clamping component is not being used).

At block 826, the process 820 includes moving the end-of-arm tool to the placement location, for example as illustrated in FIGS. 7B-7E. In various embodiments, the motion of the end-of-arm tool can be fully vertical, can have a lateral component, and/or can be fully lateral to position the target object(s) at the placement location. The motion can be controlled by the robotic unit (e.g., the robotic unit 300 of FIG. 3) under the control of the controller 109 of FIG. 1 and/or any other suitable component. In some embodiments, the process 820 implements block 826 before block 824 (e.g., when the extension portions are needed to support the target object(s) until they are released).

At block 828, the process 820 includes actuating the second clamping component away from the first clamping component. The actuation can be driven by the actuator system under the control of the controller 109 of FIG. 1 and/or any other suitable component. Further, the actuation disengages the target object(s), thereby releasing them at the placement location, without requiring the first clamping component to move. As a result, the placement location can be spaced apart from other objects (e.g., previously placed target objects) by a distance generally equal to the thickness of the first clamping component.

At block 830, the process 820 includes lifting the end-of-arm tool clear of the target object(s) and departing from the placement location. The departure can be controlled by the robotic unit (e.g., the robotic unit 300 of FIG. 3) under the control of the controller 109 of FIG. 1 and/or any other suitable component based on a planned trajectory and/or real-time information on the surrounding environment.

Once the process 820 is completed, the system can return to block 802 of FIG. 8A for the next set of one or more target object(s). In some embodiments, the parameter(s) of the next target object(s) are the same (or generally similar), allowing the system to quickly move to block 803 of the process 800 of FIG. 8A and reuse some of the planned grasping operation (e.g., a planned configuration for the end-of-arm tool). In some embodiments, the parameter(s) of the next target object are different, requiring the process 800 of FIG. 8A to plan a completely new grasping operation.

### Further Embodiments

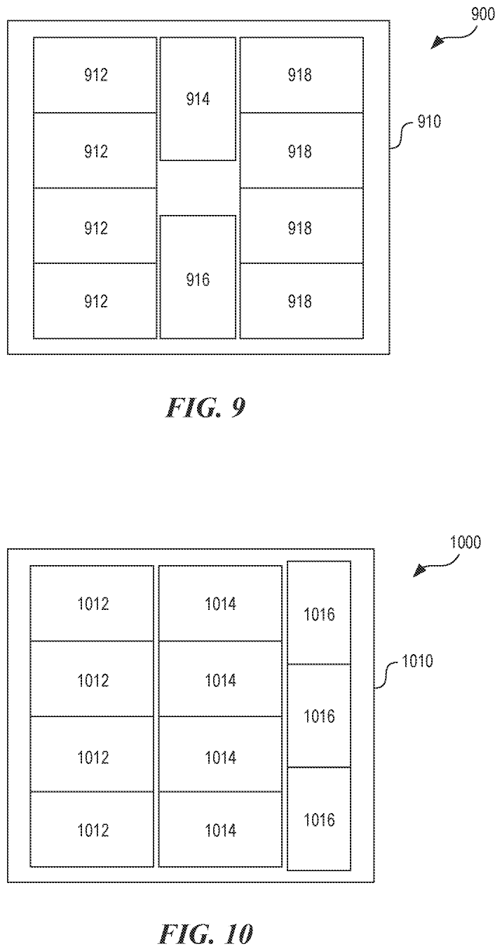

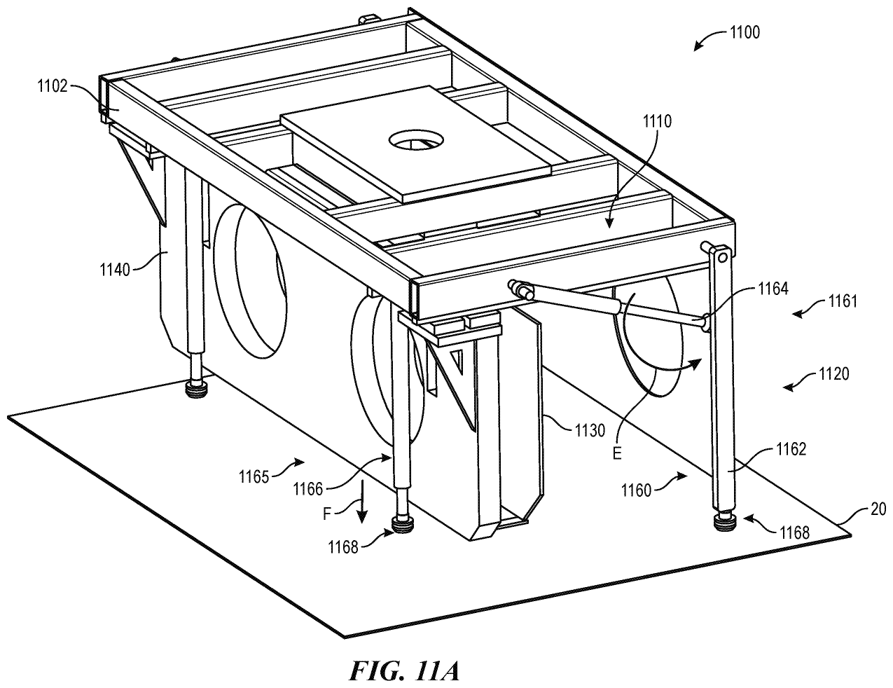

FIGS. 9 and 10 are partially schematic top views of plans 900, 1000 for packing operations in accordance with further embodiments of the present technology. The plans 900, 1000 illustrated in FIGS. 9 and 10 can be implemented to load target objects into a shipping unit 910, 1010 (e.g., as an alternative to the plan 700 of FIG. 7A based on differing weight distributions, differing sizes of target objects and/or planned perimeters, and/or any other suitable factors).

In the embodiment illustrated in FIG. 9, plan 900 includes positions for a first group of target objects 912, a second target object 914 adjacent to the first group of target objects 912, a third target object 916 adjacent to the second target object 914 and the first group of target objects 912, and a fourth group of target objects 918 adjacent to the second and third target objects 914, 916 opposite the first group of target objects 912. As further illustrated in FIG. 9, the plan 900 can require the end-of-arm tool to grasp groups of four target objects at a time. Further, in various embodiments, the end-of-arm tool can be configured to grasp one target object, two target objects, three target objects, four target objects, five target objects, and/or any other suitable group size.

In the embodiment illustrated in FIG. 10, plan 1000 includes positions for a first group of target objects 1012, a second group of target objects 1014 adjacent to the first group of target objects 1012, a third group of target objects 1016 adjacent to the second group of target objects 1014 opposite the first group of target objects 1012. As further illustrated in FIG. 10, the plan 1000 can require the end-of-arm tool to grasp groups of target objects in varying orientations and of varying sizes. For example, each of the target objects in the third group of target objects 1016 is smaller than the target objects in the second group of target objects 1014. Further, each of the target objects in the third group of target objects 1016 has a major axis that is rotated 90 degrees from a major axis of target objects in the second group of target objects 1014.

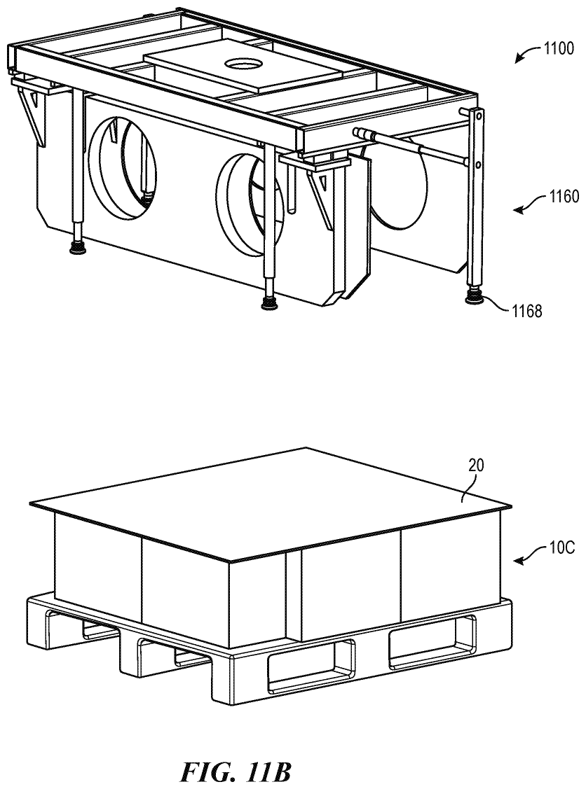

FIGS. 11A and 11B are partially schematic illustrations of an end-of-arm tool 1100 at various stages of a packing operation in accordance with further embodiments of the present technology. As illustrated in FIG. 11A, the end-of-arm tool 1100 is generally similar to the end-of-arm tool 400 discussed above with reference to FIG. 4. For example, the end-of-arm tool 1100 includes a frame 1102, as well as an actuator system 1110, a first clamping component 1120, a second clamping component 1130, and a third clamping component 1140 each carried by the frame 1102. Further, the actuator system 1110 is coupled to the first and second clamping components 1130, 1140 to move the first and second clamping components 1130, 1140 in all of the ways discussed above.

As further illustrated in FIG. 11A, the end-of-arm tool 1100 includes one or more retractable grippers 1160 (three illustrated in FIG. 11A). In the illustrated embodiment, the retractable grippers include a first gripper 1161 positionable adjacent to the first clamping component 1120 and two second grippers 1165 carried by third clamping component 1140. The first gripper 1161 includes a pivotable arm 1162, an expandable arm 1164 coupled to the pivotable arm 1162, and a suction gripping component 1168 carried by a distal end of the pivotable arm 1162. The pivotable arm 1162 is coupled to the frame 1102 and movable along a fifth motion path E between a first position (e.g., as illustrated in FIG. 4) and a second position (e.g., as illustrated in FIG. 11A) via expansion and contraction of the expandable arm 1164. In various embodiments, expandable arm 1164 can include a telescoping component (e.g., a piston), an extending track, and/or any other suitable component. When the pivotable arm 1162 is in the first position, the suction gripping component 1168 is positioned above a lowermost edge of the end-of-arm tool 1100 and therefore does not interfere with the grasping operations described above. In some embodiments (e.g., as illustrated in FIG. 4), when the pivotable arm 1162 is in the first position, the suction gripping component 1168 is at a generally similar elevation as the frame 1102 to be fully above any of the clamping components and/or any target objects engaged therein. When the pivotable arm 1162 is in the second position, the suction gripping component 1168 is positioned below the lowermost edge of the end-of-arm tool 1100.

The second grippers 1165 each include an expandable arm 1166 carried by an outer surface of the third clamping component 1140 and a suction gripping component 1168 carried by a distal end of the expandable arm 1166. Similar to the pivotable arm 1162, the expandable arm 1166 (e.g., a telescoping component, extendable track, and the like) is movable along a sixth motion path F between a first position and a second position. When the expandable arm 1166 is in the first position, the suction gripping component 1168 is positioned above a lower edge of the end-of-arm tool 1100 (e.g., at an elevation above the lower edge of the first and/or second clamping components on the end-of-arm tool 1100) and therefore does not impede the motion of the end-of-arm tool 1100 during the grasping operations described above. When the expandable arm 1166 is in the second position, the suction gripping component 1168 is positioned below the lower edge of the end-of-arm tool 1100 (e.g., at an elevation below the lower edge of the first and/or second clamping components on the end-of-arm tool 1100).

As further illustrated in FIG. 11A, when the suction gripping components 1168 are beneath the lowermost edge of the end-of-arm tool 1100, the suction gripping components 1168 can be used to grip a divider 20. The divider 20 can be a slip sheet or other suitable component that separates layers and/or groups of target objects in a shipping unit. For example, as illustrated in FIG. 11B, the end-of-arm tool can use the suction gripping components 1168 to place the divider 20 over a layer of target objects 10c before adding placing another layer.

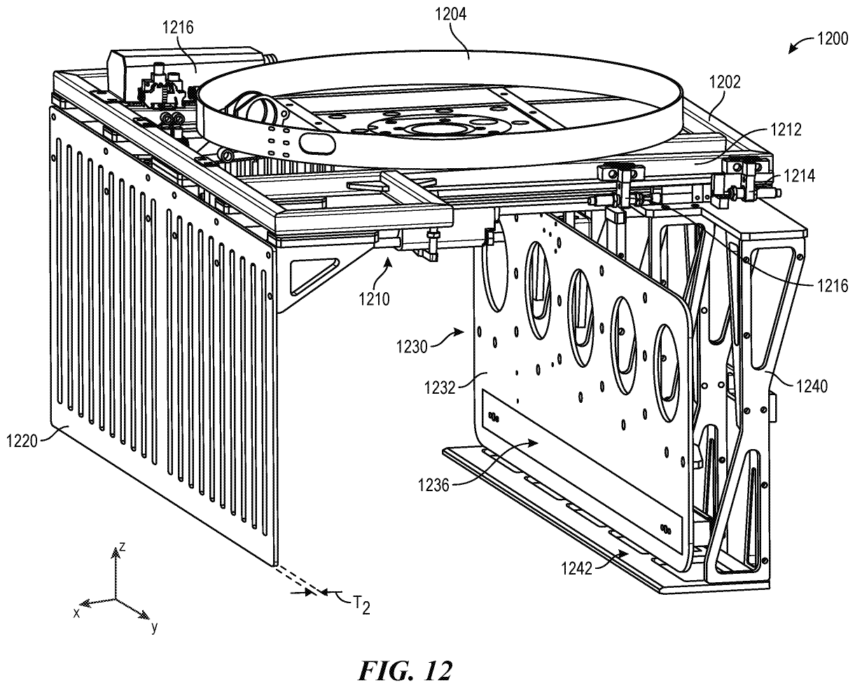

FIG. 12 is a partially schematic illustration of an end-of-arm tool configured in accordance with further embodiments of the present technology. As illustrated in FIG. 12, the end-of-arm tool 1200 is generally similar to the end-of-arm tool 400 discussed above with reference to FIG. 4. For example, the end-of-arm tool 1200 includes a frame 1202, as well as connection flange 1204, an actuator system 1210, a first clamping component 1220, a second clamping component 1230, and a third clamping component 1240 each carried by the frame 1202. Further, the actuator system includes one or more tracks 1212 (one illustrated in FIG. 12); two or more carriages 1214 (one labeled, two illustrated) coupling the second clamping component 1230 and the third clamping component 1240 to the track(s) 1212; and one or more drivers 1216 operably coupled to the carriages 1214 to drive their motion along the track(s) 1212. Further, as the carriages 1214 move along the track(s) 1212, they move a corresponding one of the second clamping component 1230 and the third clamping component 1240 toward and away from the first clamping component 1220.

FIG. 12 also illustrates details on each of the first, second, and third clamping components 1220, 1230, 1240. For example, the first clamping component 1220 is a rigid material with a thickness T₂ that is between about 1 mm and about 3 cm to reduce the between target objects that are manipulated by the end-of-arm tool 1200. The second clamping component 1230 includes a gripping substrate 1236 on the second clamping surface 1232. The gripping substrate 1236 can be a sticky material and/or a material with a relatively high coefficient of static friction. As a result, the gripping substrate 1236 can help reduce the amount that a target object between the first and second clamping components 1220, 1230 will slip. The third clamping component 1240 includes an extension portion 1242 that extends across (or generally across) the longitudinal span of the third clamping component 1240. As a result, there are no gaps in the extension portion 1242, along the extension portion 1242 to help support a target object of any size and/or thickness.

### EXAMPLES

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.

1. An end-of-arm tool, comprising:
a frame;
a first clamping component carried by the frame and extending along a first axis;
a second clamping component carried by the frame and extending along the first axis;
a third clamping component carried by the frame peripheral to the second clamping component with respect to the first clamping component, the third clamping component extending along the first axis and including one or more extension portions extending toward the first clamping component beneath a lower edge of the second clamping component; and
an actuator system carried by the frame and operably coupled to the second clamping component and the third clamping component to move the second clamping component and the third clamping component independently along a second axis at least partially orthogonal to the first axis.

2. The end-of-arm tool of example 1 wherein the actuator system includes:
a track carried by the frame and extending along the second axis;
a first carriage operably coupled between the track and the second clamping component to move the second clamping component along the second axis; and
a second carriage operably coupled between the track and the third clamping component to move the third clamping component along the second axis.

3. The end-of-arm tool of any of examples 1 and 2 wherein the second clamping component includes a bracing bracket coupled to the actuator system and extending along a third axis at least partially orthogonal to the first axis and the second axis.

4. The end-of-arm tool of example 3 wherein the third clamping component includes an opening aligned with the bracing bracket along the second axis and configured to nest with the bracing bracket when the third clamping component is adjacent to the second clamping component.

5. The end-of-arm tool of any of examples 1-4 wherein the second clamping component includes a clamping surface oriented toward the first clamping component, and wherein the second clamping component further includes a gripping substrate disposed on the clamping surface.

6. The end-of-arm tool of any of examples 1-5 wherein the first clamping component has a thickness of less than 3 centimeters.

7. The end-of-arm tool of any of examples 1-6, further comprising an imaging system carried by the frame and positioned to measure one or more parameters of a target object adjacent to the end-of-arm tool.

8. The end-of-arm tool of any of examples 1-7, further comprising one or more retractable arms carried by the frame, each of the one or more retractable arms including a suction gripping component and movable between a first position and a second position, wherein:
in the first position, the suction gripping component is at a first elevation above the lower edge of the second clamping component, and
in the second position, the suction gripping component is at a second elevation below the lower edge of the second clamping component.

9. A method for method for operating an end-of-arm tool, the method comprising:
identifying parameters of one or more target objects, the parameters including dimensions of the one or more target objects;
identifying a planned placement position for the one or more target objects at a destination;
generating commands for grasping the one or more target objects, wherein:
   the end-of-arm tool includes a frame, a first clamping component carried by the frame, a second clamping component carried by the frame, and a third clamping component carried by the frame peripheral to the second clamping component, wherein the third clamping component includes an extension portion extending toward the first clamping component beneath a lower edge of the second clamping component, and
   grasping the one or more target objects includes engaging opposing side surfaces of the one or more target objects with the first and second clamping components and engaging a lower surface of the one or more target objects with an extension portion of the third clamping component;
generating commands for transporting the one or more target objects from a pick-up location to the planned placement position at the destination; and
generating commands for releasing the one or more target objects at the planned placement position.

10. The method of example 9 wherein generating the commands for grasping the one or more target objects includes:
generating commands to align the first clamping component adjacent to a first side surface of the one or more target objects at the pick-up location;
generating commands to move the second clamping component along a transverse axis of the frame toward the first clamping component to engage a second side surface of the one or more target objects at the pick-up location; and
generating commands to move the third clamping component along the transverse axis of the frame toward the first clamping component to position the extension portion of the third clamping component beneath the lower surface of the one or more target objects.

11. The method of example 10 wherein generating the commands for grasping the one or more target objects further includes generating commands to move the end-of-arm tool, after moving the second clamping component and before moving the third clamping component, to at least partially expose the lower surface of the one or more target objects to be engaged by the extension portion of the third clamping component.

12. The method of any of examples 9-11 wherein generating the commands for releasing the one or more target objects includes:
generating commands to move the third clamping component along a transverse axis of the frame away from the first clamping component to disengage the lower surface of the one or more target objects;
generating commands to align the one or more target objects with the planned placement position;
generating commands to move the second clamping component along the transverse axis of the frame away from the first clamping component to disengage the one or more target objects; and
generating commands to lift the end-of-arm tool away from the planned placement position.

13. The method of example 12 wherein generating the commands to lift the end-of-arm tool away from the planned placement position includes generating commands to move the end-of-arm tool vertically to avoid contact moving the one or more target objects via contact with the first clamping component.

14. The method of any of examples 9-13 wherein the planned placement position is spaced apart from one or more previously placed target objects by a distance generally equal to a thickness of the first clamping component.

15. The method of example 14 wherein generating the commands for releasing the one or more target objects includes generating commands to orient the end-of-arm tool with the first clamping component between the one or more previously placed target objects and the one or more target objects.

16. A robotic system, comprising:
an object-gripping mechanism operably couplable to a robotic arm, the object-gripping mechanism including:
   a frame having a first axis and a second axis orthogonal to the first axis;
   an actuator system carried by the frame;
   an external clamping component carried by the frame, the external clamping component extending along the first axis along an outer edge of the frame;
   an internal clamping component operably coupled to the actuator system and extending along the first axis, wherein the actuator system is configured to move the internal clamping component along the second axis toward and away from the external clamping component to engage one or more target objects between the external clamping component and the internal clamping component; and
   a support clamping component operably coupled to the actuator system, the support clamping component extending along the first axis and positioned peripheral to the internal clamping component, wherein the support clamping component includes at least one extension portion extending toward the external clamping component, and wherein the actuator system is configured to move the support clamping component along the second axis toward and away from the external clamping component.

17. The robotic system of example 16 wherein the object-gripping mechanism further includes:
a first retractable gripper coupled to an outer surface of the support clamping component, wherein the first retractable gripper includes a first suction gripper, and wherein the first retractable gripper is movable between a first position to hold the first suction gripper above a lower edge of the external clamping component and a second position to hold the first suction gripper below the lower edge of the external clamping component; and
a second retractable gripper coupled to the frame, wherein the second retractable gripper includes a second suction gripper, and wherein the second retractable gripper is movable between a third position to hold the second suction gripper above a lower edge of the internal clamping component and a fourth position to hold the second suction gripper below the lower edge of the internal clamping component.

18. The robotic system of any of examples 16 and 17 wherein the actuator system is configured to move the external clamping component along the second axis toward and away from the internal clamping component.

19. The robotic system of any of examples 16-18 wherein the object-gripping mechanism further includes an imaging system carried by the frame and positioned to measure one or more parameters of a target object adjacent to the object-gripping mechanism.

20. The robotic system of any of examples 16-19 further comprising a controller operably coupled to the robotic arm and the object-gripping mechanism, the controller storing instructions that, when executed by the controller, cause the controller to:
align, via the robotic arm, the external clamping component adjacent to a first side surface of one or more target objects at a pick-up location;
move, via the actuator system, the internal clamping component along the second axis toward the external clamping component to engage a second side surface of the one or more target objects at the pick-up location and push the one or more target objects into the external clamping component; and
move, via the actuator system, the support clamping component along the second axis toward the external clamping component to position the at least one extension portion beneath a lower surface of the one or more target objects.

21. The robotic system of any of examples 16-20, further comprising the robotic arm operably coupled to the object-gripping mechanism.

### Conclusion

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within at least within 10 percent of a given value or limit. Purely by way of example, an approximate ratio means within a ten percent of the given ratio.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In a specific example, as noted above, although the end-of-arm tool has been discussed primarily herein as having a stationary first clamping component, the first clamping component can be coupled to the actuator system to move along toward and away from the second clamping component. In some embodiments, only the first clamping component is coupled to the actuator system. In such embodiments, the end-of-arm tool can be positioned with the second and third clamping components adjacent to a pick-up location (e.g., on a conveyor belt) and the first clamping component can be actuated to push one or more target objects into contact with the second clamping component and/or into a position supported by the third clamping component. In various other embodiments any of the first, second, and third clamping components can be coupled to the actuator system to move along the transvers axis as needed. In addition, certain aspects of the technology described in the context of particular embodiments may also be combined or eliminated in other embodiments. Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. An end-of-arm tool, comprising:
a frame;
a first clamping component carried by the frame and extending along a first axis;
a second clamping component carried by the frame and extending along the first axis;
a third clamping component carried by the frame peripheral to the second clamping component with respect to the first clamping component, the third clamping component extending along the first axis and including one or more extension portions extending toward the first clamping component beneath a lower edge of the second clamping component; and
an actuator system carried by the frame and operably coupled to the second clamping component and the third clamping component to move the second clamping component and the third clamping component independently along a second axis at least partially orthogonal to the first axis.

2. The end-of-arm tool of claim 1 wherein the actuator system includes:
a track carried by the frame and extending along the second axis;
a first carriage operably coupled between the track and the second clamping component to move the second clamping component along the second axis; and
a second carriage operably coupled between the track and the third clamping component to move the third clamping component along the second axis.

3. The end-of-arm tool of claim 1 wherein the second clamping component includes a bracing bracket coupled to the actuator system and extending along a third axis at least partially orthogonal to the first axis and the second axis.

4. The end-of-arm tool of claim 3 wherein the third clamping component includes an opening aligned with the bracing bracket along the second axis and configured to nest with the bracing bracket when the third clamping component is adjacent to the second clamping component.

5. The end-of-arm tool of claim 1 wherein the second clamping component includes a clamping surface oriented toward the first clamping component, and wherein the second clamping component further includes a gripping substrate disposed on the clamping surface.

6. The end-of-arm tool of claim 1 wherein the first clamping component has a thickness of less than 3 centimeters.

7. The end-of-arm tool of claim 1, further comprising an imaging system carried by the frame and positioned to measure one or more parameters of a target object adjacent to the end-of-arm tool.

8. The end-of-arm tool of claim 1, further comprising one or more retractable arms carried by the frame, each of the one or more retractable arms including a suction gripping component and movable between a first position and a second position, wherein:
in the first position, the suction gripping component is at a first elevation above the lower edge of the second clamping component, and
in the second position, the suction gripping component is at a second elevation below the lower edge of the second clamping component.

9. A method for method for operating an end-of-arm tool, the method comprising:
identifying parameters of one or more target objects, the parameters including dimensions of the one or more target objects;
identifying a planned placement position for the one or more target objects at a destination;
generating commands for grasping the one or more target objects, wherein:
the end-of-arm tool includes a frame, a first clamping component carried by the frame, a second clamping component carried by the frame, and a third clamping component carried by the frame peripheral to the second clamping component, wherein the third clamping component includes an extension portion extending toward the first clamping component beneath a lower edge of the second clamping component, and
grasping the one or more target objects includes engaging opposing side surfaces of the one or more target objects with the first and second clamping components and engaging a lower surface of the one or more target objects with an extension portion of the third clamping component;
generating commands for transporting the one or more target objects from a pick-up location to the planned placement position at the destination; and
generating commands for releasing the one or more target objects at the planned placement position.

10. The method of claim 9 wherein generating the commands for grasping the one or more target objects includes:
generating commands to align the first clamping component adjacent to a first side surface of the one or more target objects at the pick-up location;
generating commands to move the second clamping component along a transverse axis of the frame toward the first clamping component to engage a second side surface of the one or more target objects at the pick-up location; and
generating commands to move the third clamping component along the transverse axis of the frame toward the first clamping component to position the extension portion of the third clamping component beneath the lower surface of the one or more target objects.

11. The method of claim 10 wherein generating the commands for grasping the one or more target objects further includes generating commands to move the end-of-arm tool, after moving the second clamping component and before moving the third clamping component, to at least partially expose the lower surface of the one or more target objects to be engaged by the extension portion of the third clamping component.

12. The method of claim 9 wherein generating the commands for releasing the one or more target objects includes:
generating commands to move the third clamping component along a transverse axis of the frame away from the first clamping component to disengage the lower surface of the one or more target objects;
generating commands to align the one or more target objects with the planned placement position;
generating commands to move the second clamping component along the transverse axis of the frame away from the first clamping component to disengage the one or more target objects; and
generating commands to lift the end-of-arm tool away from the planned placement position.

13. The method of claim 12 wherein generating the commands to lift the end-of-arm tool away from the planned placement position includes generating commands to move the end-of-arm tool vertically to avoid contact moving the one or more target objects via contact with the first clamping component.

14. The method of claim 9 wherein the planned placement position is spaced apart from one or more previously placed target objects by a distance generally equal to a thickness of the first clamping component.

15. The method of claim 14 wherein generating the commands for releasing the one or more target objects includes generating commands to orient the end-of-arm tool with the first clamping component between the one or more previously placed target objects and the one or more target objects.

16. A robotic system, comprising:
an object-gripping mechanism operably couplable to a robotic arm, the object-gripping mechanism including:
a frame having a first axis and a second axis orthogonal to the first axis;
an actuator system carried by the frame;
an external clamping component carried by the frame, the external clamping component extending along the first axis along an outer edge of the frame;
an internal clamping component operably coupled to the actuator system and extending along the first axis, wherein the actuator system is configured to move the internal clamping component along the second axis toward and away from the external clamping component to engage one or more target objects between the external clamping component and the internal clamping component; and
a support clamping component operably coupled to the actuator system, the support clamping component extending along the first axis and positioned peripheral to the internal clamping component, wherein the support clamping component includes at least one extension portion extending toward the external clamping component, and wherein the actuator system is configured to move the support clamping component along the second axis toward and away from the external clamping component.

17. The robotic system of claim 16 wherein the object-gripping mechanism further includes:
a first retractable gripper coupled to an outer surface of the support clamping component, wherein the first retractable gripper includes a first suction gripper, and wherein the first retractable gripper is movable between a first position to hold the first suction gripper above a lower edge of the external clamping component and a second position to hold the first suction gripper below the lower edge of the external clamping component; and
a second retractable gripper coupled to the frame, wherein the second retractable gripper includes a second suction gripper, and wherein the second retractable gripper is movable between a third position to hold the second suction gripper above a lower edge of the internal clamping component and a fourth position to hold the second suction gripper below the lower edge of the internal clamping component.

18. The robotic system of claim 16 wherein the actuator system is configured to move the external clamping component along the second axis toward and away from the internal clamping component.

19. The robotic system of claim 16 wherein the object-gripping mechanism further includes an imaging system carried by the frame and positioned to measure one or more parameters of a target object adjacent to the object-gripping mechanism.

20. The robotic system of claim 16 further comprising a controller operably coupled to the robotic arm and the object-gripping mechanism, the controller storing instructions that, when executed by the controller, cause the controller to:
align, via the robotic arm, the external clamping component adjacent to a first side surface of one or more target objects at a pick-up location;
move, via the actuator system, the internal clamping component along the second axis toward the external clamping component to engage a second side surface of the one or more target objects at the pick-up location and push the one or more target objects into the external clamping component; and
move, via the actuator system, the support clamping component along the second axis toward the external clamping component to position the at least one extension portion beneath a lower surface of the one or more target objects.
